(19) United States
(12) Patent Application Publication
(10) Pub. No.: US 2025/0234202 A1
(43) Pub. Date: Jul. 17, 2025

(54) First Node, Second Node, Third Node, Communications System, and Methods Performed Thereby for Handling a Denial of Services (DoS) Attack

(71) Applicant: Telefonaktiebolaget LM Ericsson (publ), Stockholm (SE)

(72) Inventors: Victor Gomez-Hidalgo Perez, Torrijos Toledo (ES); Carlota Villasante Marcos, Madrid (ES); Miguel Angel Muñoz De La Torre Alonso, Madrid (ES)

(21) Appl. No.: 18/683,938

(22) PCT Filed: Jul. 11, 2022
(86) PCT No.: PCT/EP2022/069335

§ 371 Date: Feb. 15, 2024

(30) Foreign Application Priority Data
Aug. 19, 2021 (EP) 21382769.4

(51) Int. Cl. H04W 12/122

(52) U.S. Cl. CPC H04W 12/122

(57) ABSTRACT

A method, performed by a first node (111) operating in a communications system (100), for handling a Denial of Service (DOS) attack. The first node (111) receives (401), from a second node (112) operating outside of the communications system (100), a first message. The first message indicates i) an identifier identifying the second node (112), and ii) a first indication. The first indication indicates at least one of: i) one or more target nodes (121) outside of the communications system (100) under DOS attack, and ii) one or more source nodes (122) of the attack. The first message also indicates iii) a second indication indicating an action to be taken to mitigate the attack. The first node (111) also initiates (403) sending, directly or indirectly, a second message to one of one or more third nodes (113, 114, 115, 116, 117) in the communications system (100). The second message initiates application of the action.

### TECHNICAL FIELD

The present disclosure relates generally to a first node and methods performed thereby for handling a Denial of Service (DoS) attack. The present disclosure also relates generally to a second node, and methods performed thereby for handling the DoS attack. The present disclosure additionally relates generally to a third node, and methods performed thereby for handling the DoS attack. The present disclosure further relates generally to a communications system and methods performed thereby for handling the DoS attack.

### BACKGROUND

Computer systems in a communications network may comprise one or more network nodes. A node may comprise one or more processors which, together with computer program code may perform different functions and actions, a memory, a receiving port and a sending port. A node may be, for example, a server. Nodes may perform their functions entirely on the cloud.

The standardization organization 3GPP is currently in the process of specifying a New Radio Interface called NR or 5G-UTRA, as well as a Fifth Generation (5G) Packet Core Network, which may be referred to as 5G Core Network, abbreviated as 5GC.

FIG. 1 is a schematic diagram depicting a particular example of a 5G architecture of policy and charging control framework, which may be used as a reference for the present disclosure.

An Application Function (AF) 1, may interact with the 3GPP Core Network, and specifically in the context of this document, may allow external parties to use Exposure Application Programming Interfaces (APIs) that may be offered by the network operator. The AF 1 may be understood to operate outside of the communications system of a Mobile Network Operator (MNO). In some scenarios, the AF 1 may be part of the network of the MNO, that is, it may operate within the communication system of the MNO, e.g., an internal AF, which in that case, may usually bypass a Network Exposure Function (NEF) 2 operating in the network of the MNO. However, in the context of this document, the AF 1 may be understood to operate outside the of the communications system of the MNO.

The NEF 2 may support different functionality and, specifically in the context of this document, the NEF 2 may support different Exposure APIs. For example, 3GPP TS 29.522 v17.2.0 (June 2021): 5G System; Network Exposure Function Northbound APIs; Stage 3 describes a protocol for the NEF Northbound interface between the NEF and the AF.

A Unified Data Repository (UDR) 3 may store data grouped into distinct collections of subscription-related information, such as subscription data, policy data, structured data for exposure, and application data.

A Policy Control Function (PCF) 4 may support a unified policy framework to govern the network behavior. Specifically, the PCF may provide Policy and Charging Control (PCC) rules to the Policy and Charging Enforcement Function (PCEF), that is, the Session Management Function (SMF) 5/User Plane function (UPF) 6 that may enforce policy and charging decisions according to provisioned PCC rules.

The SMF 5 may support different functionalities, e.g., the SMF 5 may receive PCC rules from the PCF 4 and may configure the UPF 6 accordingly.

The UPF 6 may support handling of user plane (UP) traffic based on the rules received from the SMF 5, e.g., packet inspection and different enforcement actions such as Quality of Service (QoS) handling.

Also depicted in FIG. 1 is a Network Data Analytics Function (NWDAF) 7, which may be understood to represent an operator managed network analytics logical function. The NWDAF 7 may be a part of the 5GC architecture and may use the mechanisms and interfaces specified for 5GC and Operations, Administration and Maintenance (OAM). The NWDAF 7 may interact with different entities for different purposes, such as: a) data collection based on event subscription, provided by an Access and Mobility Function (AMF) 8, the SMF 5, the PCF 4, a Unified Data Management (UDM), the AF 1, directly or via the NEF 2, and an OAM; b) retrieval of information from data repositories, e.g., the UDR 3 via the UDM for subscriber-related information; c) retrieval of information about Network Functions (NFs), e.g., Network Repository Function (NRF) for NF-related information, and Network Slice Selection Function (NSSF) for slice-related information; and e) on demand provision of analytics to consumers.

FIG. 1 further depicts a Charging Function (CHF) 9. Each of the UDR 3, the NEF 2, the NWDAF 7, the AF 1, the PCF 4, the CHF 9, the AMF 8 and the SMF 5 may have an interface through which they may be accessed, which as depicted in the Figure, may be, respectively: Nudr 10, Nnef 11, Nnwdaf 12, Naf 13, Npcf 14, Nchf 15, Namf 16 and Nsmf 17. The UPF 6 may have an interface N4 18 with the SMF 5.

The communications network may cover a geographical area which may be divided into cell areas, each cell area being served by another type of node, a network node in the Radio Access Network (RAN), radio network node or Transmission Point (TP), for example, an access node such as a Base Station (BS), e.g. a Radio Base Station (RBS), which sometimes may be referred to as e.g., evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The telecommunications network may also comprise network nodes which may serve receiving nodes, such as user equipments, with serving beams.

### Denial-of-Service (DoS) Attack

In computing, a denial-of-service attack (DoS attack), e.g., a Distributed DoS (DDoS), may be understood as a cyber-attack where the perpetrator may seek to make a machine or network resource unavailable to its intended users by temporarily or indefinitely disrupting services of a host connected to the internet. Denial of service may be typically accomplished by flooding the targeted machine or resource with superfluous requests to overload systems and to prevent some or all legitimate requests from being fulfilled.

In a DDoS attack, the incoming traffic flooding the victim may originate from many different sources. This effectively makes it impossible to stop the attack simply by blocking a single source.

There may be different types of DDoS attacks: a) volume-based attacks, which may use high traffic to inundate the network bandwidth, b) protocol attacks, which may focus on exploiting server resources, and c) application attacks, which may focus on web applications and may be considered the most sophisticated and serious type of attacks.

Examples of DDoS attacks may be: SYN flood, User Datagram Protocol (UDP) flood, Hypertext Transport Protocol (HTTP) flood, Ping of death, Smurf attack, Fraggle attack, Slowloris, Network Time Protocol (NTP) amplification, Advanced Persistent DoS, Zero-day DDoS attacks, etc.

Network operators are challenged due to the exponential increase of connected devices, both mobile broadband and IoT devices, which implies much higher probability of security vulnerabilities and threats, for example, according to the DoS attacks just described.

### SUMMARY

It is an object of embodiments herein to improve the handling of security attacks to external parties using a communications system. It is a particular object of embodiments herein to improve the handling of a DoS, e.g., DDoS, attack.

According to a first aspect of embodiments herein, the object is achieved by a method, performed by a first node. The method is for handling a DoS attack. The first node operates in a communications system. The first node receives, from a second node operating outside of the communications system, a first message. The first message indicates: i) an identifier identifying the second node, ii) a first indication indicating at least one of: a) one or more target nodes operating outside of the communications system under DoS attack, and b) one or more source nodes of the DoS attack, and iii) a second indication indicating an action to be taken in the communications system to mitigate the DoS attack. The first node then initiates sending, directly or indirectly, a second message to one of one or more third nodes operating in the communications system. The second message is based on the received first message. The second message initiates an application of the indicated action in the communications system.

According to a second aspect of embodiments herein, the object is achieved by a method, performed by a third node. The method is for handling a DoS attack. The third node operates in a communications system. The third node receives, directly or indirectly, from the first node operating in the communications system, the second message. The second message indicates: i) the first indication indicating at least one of: a) the one or more target nodes operating outside of the communications system under DoS attack, and b) the one or more source nodes of the DoS attack, and ii) the second indication indicating the action to be taken in the communications system to mitigate the DoS attack. The third node then initiates an application of the indicated action in the communications system.

According to a third aspect of embodiments herein, the object is achieved by a method, performed by the second node. The method is for handling the DoS attack. The second node sends the first message to the first node operating in the communications system. The second node operates outside of the communications system. The first message indicates: i) the identifier identifying the second node, ii) the first indication indicating at least one of: a) the one or more target nodes operating outside of the communications system under DoS attack, and b) the one or more source nodes of the DoS attack, and iii) the second indication indicating the action to be taken in the communications system to mitigate the DoS attack.

According to a fourth aspect of embodiments herein, the object is achieved by a method, performed by the communications system. The method is for handling the DoS attack. The communications system comprises the first node and the one or more third nodes. The method comprises receiving, by the first node, from the second node operating outside the communications system, the first message. The first message indicates: i) the identifier identifying the second node, ii) the first indication indicating at least one of: a) the one or more target nodes operating outside of the communications system under DoS attack, and b) the one or more source nodes of the DoS attack, and iii) the second indication indicating the action to be taken in the communications system to mitigate the DoS attack. The first node then initiates sending, directly or indirectly, the second message to one of the one or more third nodes operating in the communications system. The second message is based on the received first message. The second message initiates the application of the indicated action in the communications system. The method comprises receiving, directly or indirectly, by the one or more third nodes, from the first node, the second message. The method then comprises initiating, by the one or more third nodes, the application of the indicated action in the communications system.

According to a fifth aspect of embodiments herein, the object is achieved by the first node, for handling the DoS attack. The first node is configured to operate in the communications system. The first node is further configured to receive, from the second node configured to operate outside of the communications system, the first message. The first message is configured to indicate: i) the identifier configured to identify the second node, ii) the first indication configured to indicate at least one of: i) the one or more target nodes configured to operate outside of the communications system under DoS attack, and ii) the one or more source nodes of the DoS attack, and iii) the second indication configured to indicate the action to be taken in the communications system to mitigate the DoS attack. The first node is also configured to initiate sending, directly or indirectly, the second message to one of the one or more third nodes configured to operate in the communications system. The second message being configured to be based on the first message configured to be received. The second message is configured to initiate the application of the action in the communications system configured to be indicated.

According to a sixth aspect of embodiments herein, the object is achieved by the third node, for handling the DoS attack. The third node is configured to operate in the communications system. The third node is further configured to receive, directly or indirectly, from the first node configured to operate in the communications system, the second message. The second message is configured to indicate: i) the first indication configured to indicate at least one of: a) the one or more target nodes configured to operate outside of the communications system under DoS attack, and b) the one or more source nodes of the DoS attack, and ii) the second indication configured to indicate the action to be taken in the communications system to mitigate the DoS attack. The third node is also configured to initiate the application of the indicated action in the communications system.

According to a seventh aspect of embodiments herein, the object is achieved by the second node, for handling the DoS attack. The second node is further configured to send the first message to the first node configured to operate in the communications system. The second node is configured to operate outside of the communications system. The first message is configured to indicate: i) the identifier configured to identify the second node, ii) the first indication configured to indicate at least one of: i) the one or more target nodes configured to operate outside of the communications system under DoS attack, and ii) the one or more source nodes of the DoS attack, and iii) the second indication configured to indicate the action to be taken in the communications system to mitigate the DoS attack.

According to an eighth aspect of embodiments herein, the object is achieved by the communications system, for handling the DoS attack. The communications system is configured to comprise the first node and the one or more third nodes. The communications system is further configured to receive, by the first node, from the second node configured to operate outside of the communications system, the first message. The first message is configured to indicate: i) the identifier configured to identify the second node, ii) the first indication configured to indicate at least one of: i) the one or more target nodes configured to operate outside of the communications system under DoS attack, and ii) the one or more source nodes of the DoS attack, and iii) the second indication configured to indicate the action to be taken in the communications system to mitigate the DoS attack. The communications system is further configured to initiate sending, directly or indirectly, by the first node, the second message to one of the one or more third nodes configured to operate in the communications system. The second message being configured to be based on the first message configured to be received. The second message is configured to initiate the application of the action configured to be indicated in the communications system. The communications system is further configured to receive, directly or indirectly, by the one or more third nodes, from the first node, the second message. The communications system is further configured to initiate, by the one or more third nodes, the application of the action configured to be indicated, in the communications system.

By the second node sending the first message to the first node, indicating the one or source nodes, the one or more target nodes, or both, and the action to mitigate the DoS attack, the second node, e.g., a content provider, may be enabled to rely on the network resources of an operator of the communications system to mitigate DoS, e.g., DDoS attacks. This may be understood to be advantageous as the resources of the communications system may be understood to be usually larger than those of content providers.

The indication of the identifier of the second node may enable the first node to determine if the second node may be authorized to send the request.

By receiving the first message and initiating sending the second message indicating the action to mitigate the DoS attack indicated by the second node, the first node may facilitate application of the action, using the resources of the communications system. The first node may enable the application of the action by initiating sending the second message to the one or more third nodes comprised in the communications system, which may apply the action individually, or in e.g., sequential communication, with each other.

By the one or more third nodes receiving the second message and initiating application of the action, the first node, and/or the one or more third nodes, may enable to mitigate the DoS attack, with the action indicated by the second node. This may be advantageous as it may be understood to use the knowledge of the second node, e.g., to which servers other than the target node/s the traffic may be able to be redirected, with the resources of the communications system, which may be understood to be larger and more scalable, than those of the content provider alone.

The mitigation of the action may be enabled to be performed, by ensuring for example, that only legitimate requests may reach the service providers sites. The communications system may therefore be enabled to offer, e.g., as a function, a firewall as an open platform to content providers, so that the more scalable firewall functions of the MNO may be outsourced to the MNO.

By receiving the first message and initiating sending the second message indicating the action requested by the second node, the first node may also allow an MNO to help a content provider to keep a service alive, and to mitigate the attack. This may be performed, for example by, e.g., using the redirection capacity and its geo redundancy Content Delivery Networks (CDNs). Examples herein may provide the mitigation by balancing the traffic-attack to other locations, or by blocking directly from the network before an attack-traffic may reach the servers.

By the first message indicating the first indication, indicating the source nodes and/or the target nodes of the DoS attack, embodiments herein may allow to convey firewall policies for service providers sites, through a new exposure API for sending the firewall rules to apply from the application servers to the network providers, e.g., deny traffic when a source may be A.B.C.D/X and a destination may be a Movie streaming application site.

One further advantage of embodiments herein is that they may allow load balancing and scalation capabilities, through a new exposure API for requesting load balancing to the network, e.g., servers of a Movie streaming application in the USA are under attack and the Movie streaming application may request the network to redirect part of the traffic to other geographical sites.

By initiating instructing, the first node may trigger data collection from the entities in the communications network which may be able to provide information on the one or more applications and/or the one or more devices that may be the target or the source of the security attack of the first type, so that after receiving the information, the first node may be enabled to perform an analysis of the information and determine if an attack may be underway, or may have happened.

The second node, by receiving the second message, may be enabled start monitoring the requested first information, and when appropriate, e.g., on-demand, when a condition is met, or periodically, send the collected first information to the first node, thereby enabling the first node to analyze the information and determine whether or not the attack has taken place, and by whom, so that actions to mitigate such an attack may be taken.

By the first node initiating sending the another message if the attack has been detected, the first node may then enable the another node to be notified about any security attack that may be underway, or may have happened in the communications system, and thereby enable the another node to take appropriate measures to stop the attack and mitigate any adverse effects the attack may have on the operation of the communications system and/or its components. The capacity of the communications system may therefore by improved and the latency may be reduced.

### BRIEF DESCRIPTION OF THE DRAWINGS

Examples of embodiments herein are described in more detail with reference to the accompanying drawings, according to the following description.

FIG. 1 is a schematic diagram illustrating a non-limiting example of a 5G Network Architecture.

FIG. 2 is a schematic diagram illustrating problems with existing solutions.

FIG. 3 is a schematic diagram illustrating a non-limiting example of a communications system, according to embodiments herein.

FIG. 4 is a flowchart depicting embodiments of a method in a first node, according to embodiments herein.

FIG. 5 is a flowchart depicting embodiments of a method in a third node, according to embodiments herein.

FIG. 6 is a flowchart depicting embodiments of a method in a second node, according to embodiments herein.

FIG. 7 is a flowchart depicting embodiments of a method in a communications system, according to embodiments herein.

FIG. 8 is a schematic diagram depicting a non-limiting example of signalling between nodes in a communications system, according to embodiments herein.

FIG. 9 is a schematic diagram depicting another non-limiting example of signalling between nodes in a communications system, according to embodiments herein.

FIG. 10 is a schematic block diagram illustrating two non-limiting examples, a) and b), of a first node, according to embodiments herein.

FIG. 11 is a schematic block diagram illustrating two non-limiting examples, a) and b), of a second node, according to embodiments herein.

FIG. 12 is a schematic block diagram illustrating two non-limiting examples, a) and b), of a third node, according to embodiments herein.

FIG. 13 is a schematic block diagram illustrating two non-limiting examples, a) and b), of a communications system, according to embodiments herein.

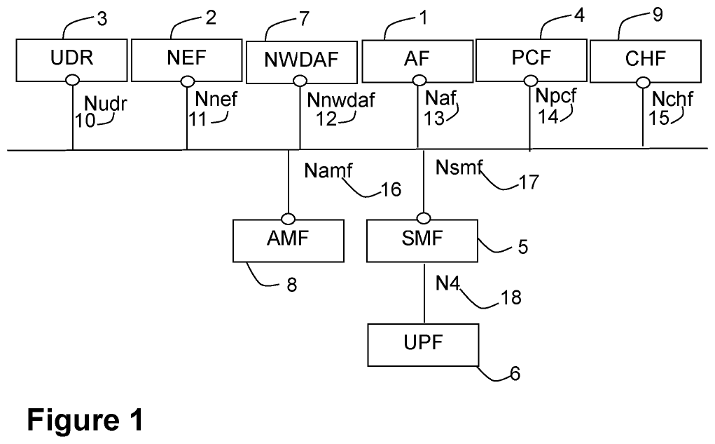

### DETAILED DESCRIPTION

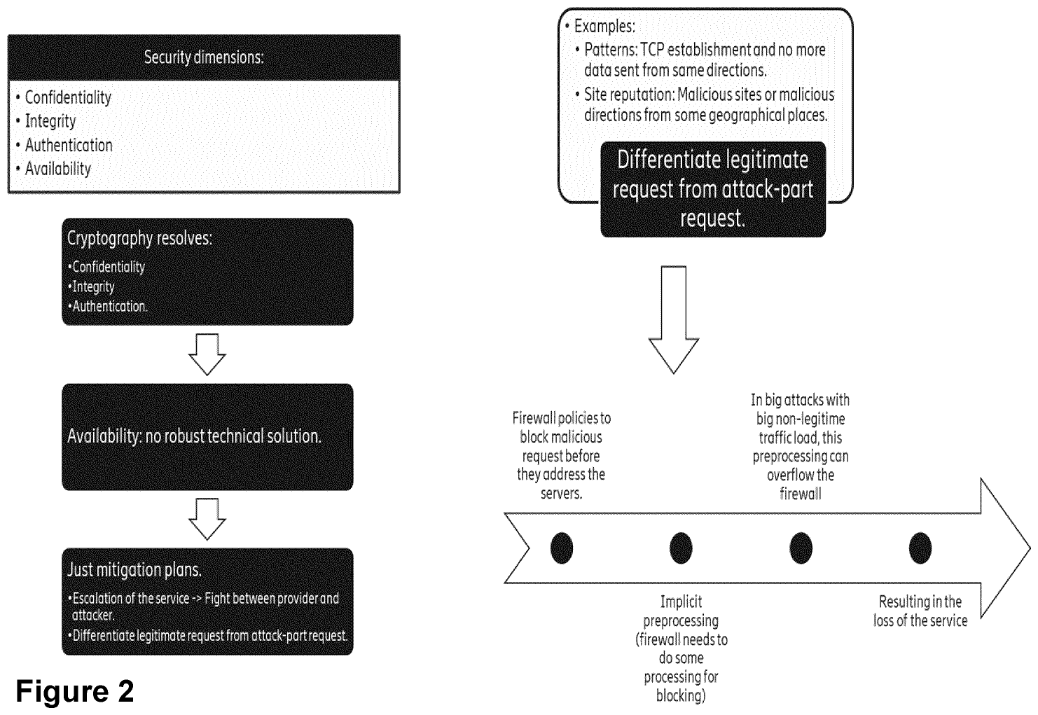

As part of the development of embodiments herein, one or more challenges with the existing technology will first be identified and discussed. To that effect, some considerations about the problem space related to the existing solutions to handle DoS attacks made by the inventors of the embodiments herein may be helpful for the understanding of the embodiments herein described. FIG. 2 is a schematic diagram depicting a summary of such considerations related to the existing solutions to handle DoS attacks, particularly DDoS attacks. As indicated in FIG. 2, security dimensions comprise confidentiality, integrity, authentication and availability. Cryptography techniques resolve confidentiality, integrity, authentication issues. However, regarding DoS, e.g., DDoS, attacks, there is currently no robust technical solution for availability. Regarding DoS attacks and mitigation, the existing solutions comprise scalation of the service, by overprovisioning bandwidth, and/or through geographical redundancy, and approaches to differentiate a legitimate request from an attack-part request. Regarding the approach to overprovision bandwidth, overprovisioning by 100% or 500%, will most likely not stop a DoS attack. Such an approach may only give a few extra minutes to act before the content provider resources are overwhelmed. Through the geographical redundancy approach, a content provider may keep a service alive, but this does not mitigate the attack.

The approach to differentiate a legitimate request from an attack-part request is usually performed by a Firewall entity at the content provider site. Examples of this approach may comprise detection of patterns and Transmission Control Protocol (TCP) establishment so that no more data sent from the same directions, and determination of a site reputation, thereby enabling to determine malicious sites or malicious directions from geographical places. Firewall polices may be established to block a malicious request before it may address the servers. This comprises an implicit preprocessing. That is, the firewall may need to perform some preprocessing for blocking the request. However, in big attacks with big non-legitime traffic load, this pre-processing may overflow the firewall, resulting in the loss of the service.

To handle security attacks, existing gateways may provide some basic security functions, such as DDoS detection. However, those security functions are performed locally, under static configuration, and not dynamically, with better efficiency. Furthermore, traffic encryption is a growing trend in mobile networks and at the same time, the encryption mechanisms are growing in complexity. Domain Name System (DNS) traffic today is starting to be encrypted, e.g., DNS over Hypertext Transport Protocol Secure (DoH), DNS over Transport Layer Security (DoT). In the future, it is expected that most DNS traffic will be encrypted. Most applications today are encrypted, e.g., Hypertext Transport Protocol Secure (HTTPS), Transport Layer Security (TLS) or Quick User Datagram Protocol Internet Connection (QUIC). In the future, it is foreseen that most applications will be based on QUIC. Furthermore, it is expected that the TLS/QUIC Server Name Indication (SNI) field will also be encrypted.

It is more complex to detect security related attacks at the UPF when traffic is encrypted, specifically when both the DNS traffic and TLS/QUIC SNI are encrypted. This applies both to HTTPS, HTTP/HTTP2 over TLS, and to QUIC based applications, e.g., HTTP3 over QUIC.

Certain aspects of the present disclosure and their embodiments address one or more of these challenges identified with the existing methods and provide solutions to the challenges discussed. Embodiments herein may therefore be understood to relate in general to security related attack prevention in a communications system. Embodiments herein may be understood to more particularly relate to API exposure for DoS, e.g., DDoS, mitigation in 5G or 4G networks. Particular embodiments herein may provide a a mechanism which may solve the problems discussed in the Summary section and may be based on the definition of a new exposure API for a content provider to request an MNO to apply DoS, e.g., DDoS, mitigation actions to the affected traffic.

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

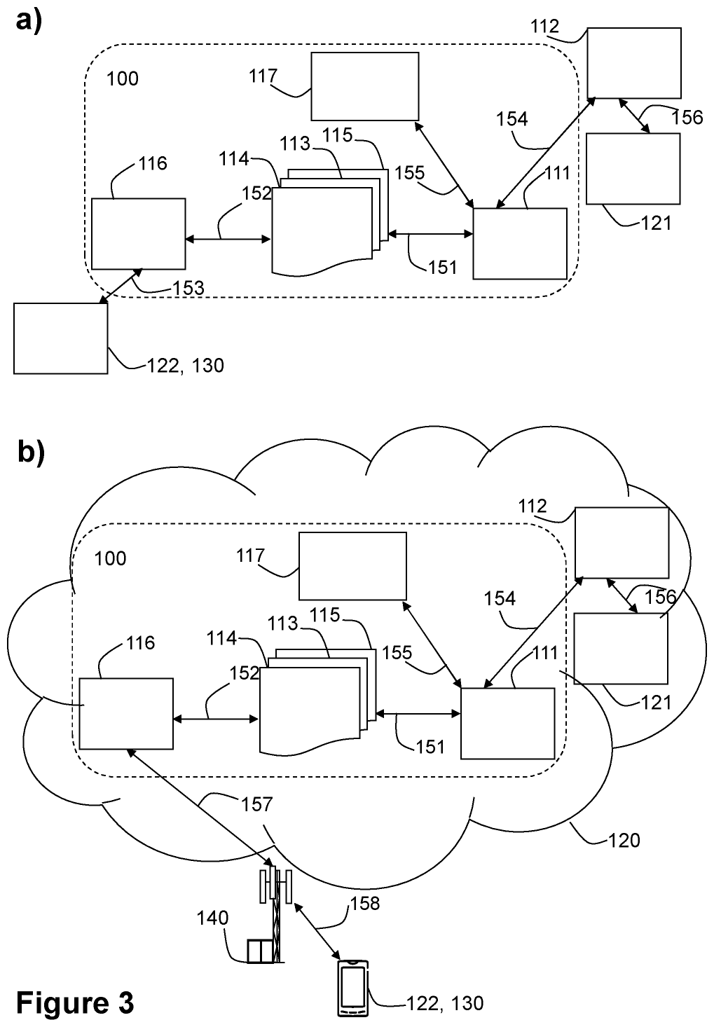

FIG. 3 depicts two non-limiting examples, in panels “a” and “b”, respectively, of a communications system 100, in which embodiments herein may be implemented. In some example implementations, such as that depicted in the non-limiting example of FIG. 3a, the communications system 100 may be a computer network. In other example implementations, such as that depicted in the non-limiting example of FIG. 3b, the communications system 100 may be implemented in a telecommunications system, sometimes also referred to as a telecommunications network, cellular radio system, cellular network or wireless communications system. In some examples, the telecommunications system may comprise network nodes which may serve receiving nodes, such as wireless devices, with serving beams.

In some examples, the telecommunications system may for example be a network such as 5G system, or a newer system supporting similar functionality. In other examples, the telecommunications system may for example be a 4G system technologies, such as a Long-Term Evolution (LTE) network, e.g. LTE Frequency Division Duplex (FDD), LTE Time Division Duplex (TDD), LTE Half-Duplex Frequency Division Duplex (HD-FDD), LTE operating in an unlicensed band. The telecommunications system may also support other technologies, such as Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band IoT (NB-IoT).

Although terminology from Long Term Evolution (LTE)/5G has been used in this disclosure to exemplify the embodiments herein, this should not be seen as limiting the scope of the embodiments herein to only the aforementioned system. Other wireless systems support similar or equivalent functionality may also benefit from exploiting the ideas covered within this disclosure. In future telecommunication networks, e.g., in the sixth generation (6G), the terms used herein may need to be reinterpreted in view of possible terminology changes in future technologies.

The communications system 100 may comprise a plurality of nodes, whereof a first node 111 is depicted in FIG. 3. The first node 111 may be configured to communicate with a second node 112, which may be configured to operate outside of the communications system 100. The communications system 100 may further comprise one or more third nodes 113, 114, 115, 116, 117, also depicted in FIG. 3. The one or more third nodes 113, 114, 115, 116, 117 may comprise a first third node 113, a second third node 114, a third third node 115, a fourth third node 116 and a fifth third node 117.

Any of the first node 111, the second node 112 and the one or more third nodes 113, 114, 115, 116, 117 may be understood, respectively, as a first computer system, a second computer system, and one or more third computer systems. In some examples, any of the first node 111, the second node 112 and the one or more third nodes 113, 114, 115, 116, 117 may be implemented as a standalone server in e.g., a host computer in the cloud 120. Any of the first node 111, the second node 112 and the one or more third nodes 113, 114, 115, 116, 117 may in some examples be a distributed node or distributed server, with some of their respective functions being implemented locally, e.g., by a client manager, and some of its functions implemented in the cloud 120, by e.g., a server manager. Yet in other examples, any of the first node 111, the second node 112 and the one or more third nodes 113, 114, 115, 116, 117 may also be implemented as processing resources in a server farm.

In some embodiments, any of the first node 111 and the one or more third nodes 113, 114, 115, 116, 117 may be independent and separated nodes. In other embodiments, any of the first node 111 and the one or more third nodes 113, 114, 115, 116, 117 may be co-located or be the same node. All the possible combinations are not depicted in FIG. 3 to simplify the Figure. It may be understood that the communications system 100 may comprise more nodes than those represented in FIG. 3.

Any of the first node 111 and the one or more third nodes 113, 114, 115, 116, 117 may be core network nodes in the communications system 100.

In some examples of embodiments herein, the first node 111 may be a node having a capability to expose different functions of the communications system 100, by e.g., supporting different exposure APIs. The first node 111 may be, for example, a NEF in 5G, a Service Capability Exposure Function (SCEF) in 4G, or a node capable of performing a similar function in the communications system 100.

The second node 112 may be a node having a capability to interact with the communications system 100, e.g., a 3GPP Core Network, and allow external parties to use APIs that may be offered by an operator of the communications system 100. The second node 112 may be, for example, an AF in 5G, a Service Capability Server (SCS)/Application Server (AS) in 4G, or a node capable of performing a similar function in the communications system 100. The second node 112 may be managed, or under the control of, a content provider, or may be managed by a third party.

The one or more third nodes 113, 114, 115, 116, 117 may be other nodes in the communications system having a capability to receive direct or indirect communications from the first node 111.

The first third node 113 may be a node having a capability to support a unified policy framework to govern the network behavior. The first third node 113 may provide rules to a policy enforcement function that may enforce policy decisions according to provisioned rules. The first third node 113 may be, for example, a PCF in 5G, an PCRF in 4G, or a node capable of performing a similar function in the communications system 100.

The second third node 114 may be a node having a capability to store data, e.g., grouped into distinct collections of subscription-related information, such as subscription data, policy data, structured data for exposure, and application data. The second third node 114 may be a UDR in 5G, and Subscriber Profile Repository (SPR) in 4G, or a node capable of performing a similar function in the communications system 100.

The third third node 115 may be a node having a capability to support different functionalities, e.g., it may receive rules from the first third node 113 and may configure the fourth third node 116 accordingly. The third third node 115 may be an SMF in 5G, a Packet Data Network (PDN) Gateway Control plane function (PGW-C) or Traffic Detection Function Control plane function (TDF-C) in 4G, or a node capable of performing a similar function in the communications system 100.

The fourth third node 116 may be a node having a capability to support handling of user plane (UP) traffic based on the rules received from the third third node 115, e.g., packet inspection and different enforcement actions such as Quality of Service (QoS) handling. The fourth third node 116 may be an UPF in 5G, a PDN Gateway User plane function (PGW-U) or Traffic Detection Function User plane function (TDF-U) in 4G, or a node capable of performing a similar function in the communications system 100.

The fifth third node 117 may be a node capable of performing analytics on user data, e.g., via machine-learning techniques, such as building prediction models of different events, e.g., imminent DoS attacks, related to the communications system 100. The fifth third node 117 may, in some examples, be operated by a third party, outside of a core network of the communications system 100.

Also depicted in FIG. 3 are one or more target nodes 121 and one or more source nodes 122. The one or more target nodes 121 may operate outside of the communications system 100, and be under DoS attack. The one or more target nodes 121 may for example be one or more AS providing application content to users of the communications system 100. The one or more source nodes 122 may be understood as the source of the DoS attack. In some examples, such as those depicted in FIG. 3, at least one of the one or more source nodes 122 may be a device 130.

The device 130 may be also known as e.g., user equipment (UE), a wireless device, mobile terminal, wireless terminal and/or mobile station, mobile telephone, cellular telephone, or laptop with wireless capability, or a Customer Premises Equipment (CPE), just to mention some further examples. The device 130 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet, a Machine-to-Machine (M2M) device, a device equipped with a wireless interface, such as a printer or a file storage device, modem, Laptop Embedded Equipped (LEE), Laptop Mounted Equipment (LME), USB dongles or any other radio network unit capable of communicating over a radio link with the communications system 100. The device 130 may be wireless, i.e., it may be enabled to communicate wirelessly with the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system 100. In some particular embodiments, any of the device 130 may be an IoT device, e.g., a NB IoT device.

The device 130 may communicate with the communications system 100 via one or more radio network nodes, whereof a radio network node 140 is depicted in FIG. 3b. The radio network node 140 may typically be a base station or Transmission Point (TP), or any other network unit capable to serve a wireless device or a machine type node. The radio network node 140 may be e.g., a 5G gNB, a 4G eNB, or a radio network node in an alternative 5G radio access technology, e.g., fixed or WiFi. The radio network node 140 may be e.g., a Wide Area Base Station, Medium Range Base Station, Local Area Base Station and Home Base Station, based on transmission power and thereby also coverage size. The radio network node 140 may be a stationary relay node or a mobile relay node. The radio network node 140 may support one or several communication technologies, and its name may depend on the technology and terminology used. The radio network node 140 may be directly connected to one or more networks and/or one or more core networks.

The communications system 100 covers a geographical area which may be divided into cell areas, wherein each cell area may be served by a radio network node, although, one radio network node may serve one or several cells.

The first node 111 may communicate with any of the one or more third nodes 113, 114, 115, 116, 117, e.g., with any of the first third node 113 or the second third node 114, respectively, over a respective first link 151, e.g., a radio link or a wired link. The third third node 115 may communicate with the fourth third node 116 over a second link 152, e.g., a radio link or a wired link. The fourth third node 116 may communicate with any of the one or more source nodes 122, e.g., the device 130, respectively, over a respective third link 153, e.g., a radio link or a wired link. The second node 112 may communicate with the first node 111 over a fourth link 154, e.g., a radio link or a wired link. The fifth third node 117 may communicate with the first node 111 over a fifth link 155, e.g., a radio link or a wired link. The second node 112 may communicate with any of the one or more target nodes 121, respectively, over a respective sixth link 156, e.g., a radio link or a wired link. The radio network node 140 may communicate with the fourth third node 116 over a seventh link 157, e.g., a radio link. The radio network node 140 may communicate with any of the one or more source nodes 122, e.g., the device 130, respectively, over a respective eighth link 158, e.g., a radio link. Any of the respective first link 151, the second link 152, the third link 153, the fourth link 154, the fifth link 155 and the respective sixth link 156 may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 3.

In general, the usage of “first”, “second”, “third”, “fourth”, “fifth”, “sixth”, “seventh” and/or “eighth” herein may be understood to be an arbitrary way to denote different elements or entities, and may be understood to not confer a cumulative or chronological character to the nouns these adjectives modify.

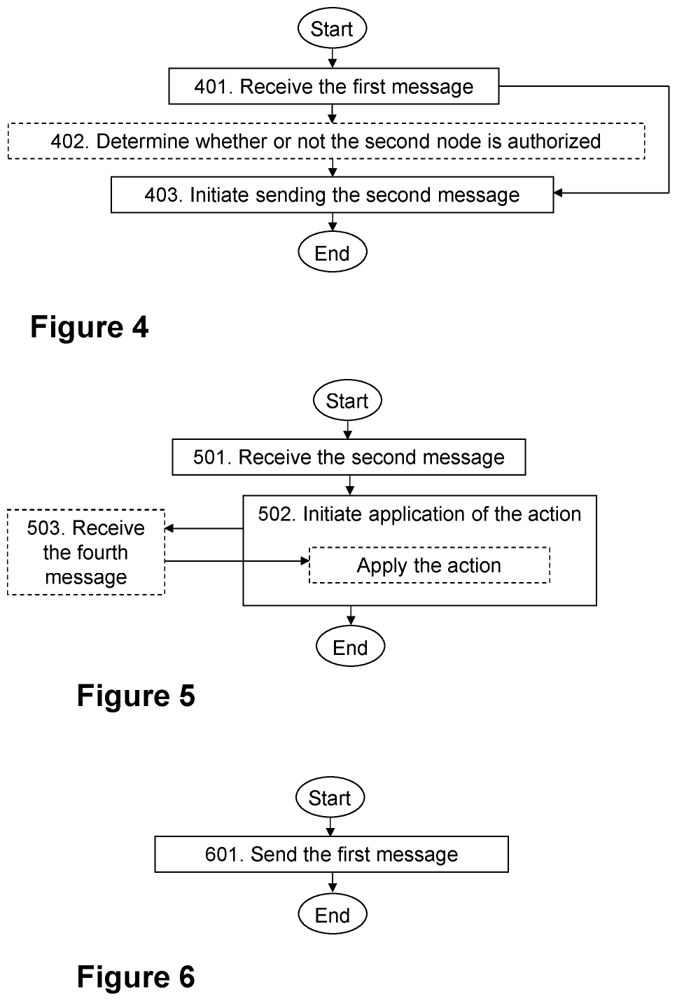

Embodiments of a method, performed by the first node 111, will now be described with reference to the flowchart depicted in FIG. 4. The method may be understood to be for handling a DoS attack. The first node 111 operates in the communications system 100.

The method may comprise the actions described below. In some embodiments all the actions may be performed. In some embodiments some of the actions may be performed. In FIG. 4, an optional action is indicated with a dashed box. One or more embodiments may be combined, where applicable. All possible combinations are not described to simplify the description. It should be noted that the examples herein are not mutually exclusive. Components from one example or embodiment may be tacitly assumed to be present in another example or embodiment and it will be obvious to a person skilled in the art how those components may be used in the other examples or embodiments.

### Action 401

During the course of operations of the communications system 100, the communications system 100 may be vulnerable to security attacks. A security attack may be understood as any interference in any process or component of the communications system 100 with the intent to affect its functioning or performance, and/or to steal part of the information processed by it. A security attack may be which may be of different types, one of which may be a DoS attack, e.g., a DDoS attack.

Embodiments herein provide for a mechanism whereby a content provider, e.g., an AF, such as the second node 112, may request an MNO, through the first node 111, e.g., a NEF, to apply a requested mitigation action for certain traffic. This may be performed via, e.g., a new Nnef API/service, e.g., Nnef_Security.

In this Action 401, the first node 111 receives, from the second node 112 operating outside of the communications system 100, a first message. The first message indicates an identifier identifying the second node 112. The identifier may be, for example, an AF-ID, which may for example identify the content provider. The first message also indicates a first indication indicating at least one of: i) the one or more target nodes 121 operating outside of the communications system 100 under DoS attack, and ii) the one or more source nodes 122 of the DoS attack, e.g., at least one of which may be a device 130. The first message further indicates a second indication indicating an action to be taken in the communications system 100 to mitigate the DoS attack.

The first indication may comprise at least one of: one or more Packet Flow Descriptions (PFDs), and one or more application identifiers. The first indication may comprise, e.g., a List of PFDs. That is, in some embodiments, the first indication may comprise a list of traffic filters in Packet Flow Description (PFD) format, as n-tuples, such as, for example, IP addresses of servers under DDoS attack and/or source IP addresses generating DDoS attacks. One example may be PFDs including source A.B.C.D/X and a destination being a set of server sites from a movie streaming application. Alternatively, a list of App-ID may be indicated or a traffic category, e.g. video streaming, which may allow the second node 112 to request the MNO to detect generic video streaming traffic, irrespective of the application, e.g., both Application 1 and Application 2 video streaming may match. This case may apply when there may be server virtualization and behind an IP address there may be more than one service provider. Since it may not be possible to block traffic based on the IP destination, it may be necessary to classify traffic to identify the specific traffic for applying only to it the requested mitigation action.

According to the foregoing, in some embodiments, the first indication may comprise a respective internet protocol (IP) address for each of the one or more source nodes 122.

In other embodiments, the first indication may lack the respective IP address for each of the one or more source nodes 122.

The action may be also referred to herein as a mitigation action. The action may be indicated by a parameter, e.g., “Mitigation-Action”, which may indicate the action or actions to be applied to the traffic matching the first indication, e.g., the list of PFD.

In some embodiments, the action may be at least one of: redirect traffic, block traffic, tear down connections, send traffic to an analytics engine, apply edge computing logic, and apply an authentication service. For example, the traffic may be redirected to another AS. The analytics engine may be, e.g., the fifth third node 117.

To redirect traffic may comprise to redirect traffic towards a certain set of application servers, which may be provided by the second node 112, towards a network security entity or towards a certain slice, e.g., handling DDoS traffic. The second node 112 may request, e.g., by including a flag, the communications system 100 to analyze suspicious traffic, e.g., when it may not be clear whether this traffic may or may not attack-part, and then apply the action based on the analysis. The MNO may provide this service, similar to an Intrusion Detection System (IDS).

Reporting traffic towards the analytics engine, e.g., a NWDAF, may enable that the analytics engine may then use this information for training ML models for DDoS.

To request the MNO to apply edge computing logic, may be requested, e.g., when the second node 112 second node 112 may detect a DDoS attack, or an overload situation, and it may ask the MNO to put the service “closer” to the user. Edge computing may usually aim to lower the latency to improve the user application experience, but it may also be applied for DDoS and server overload scenarios.

With regards to the option to request the MNO to apply an authentication service, e.g., during the DDoS attack, all the non-authenticated connections may be redirected from the network to an authentication server, before reaching the servers of a content provider. Only the authenticated connections may be allowed to reach the servers of the content provider.

In other embodiments, the first message may be a Nnef_Security Request message.

### Action 402

The first node 111, e.g., the NEF security API of the first node 111, may also be used by an external third party, e.g., a security company may detect DDoS attacks and act on behalf of the content provider. In this case, the security company may need to be authorized, both by the content provider and by first node 111, to use the security API of the first node 111.

Before authorization, in case the second node 112 may request to block traffic based on IP destination, the first node 111 may need to validate that those IPs belong to the content provider. In this Action 402, the first node 111 may determine whether or not the second node 112 may be authorized to request the action to be taken. This Action 402 is optional, as indicated by the direct arrow from Action 401 to Action 403 in FIG. 4. Nevertheless, from a security perspective, it may be understood to be advantageous to perform Action 402, as indicated by the arrows between Action 401->Action 402->Action 403 in FIG. 4.

This may be done by keeping a database, e.g., a mapping between content providers and their IP addresses, in the second third node 114, e.g., a UDR. If the first node 111 does not perform this, there may be a clear vulnerability, e.g., a movie stream application 1 may ask the first node 111 to block traffic of movie stream application 2.

### Action 403

In this Action 403, the first node 111 may initiate sending, directly or indirectly, a second message to one of one or more third nodes 113, 114, 115, 116, 117 operating in the communications system 100. The second message is based on the received first message. The second message initiates an application of the indicated action in the communications system 100.

The second message may indicate at least one of: a) the identifier, the first indication and the second indication, and b) the first indication and the second indication.

That is, that the second message is based on the received first message may be understood to mean that in some examples, the second message may have the same content as the first message, that is, the identifier, the first indication and the second indication. This may apply, for example, when the first node 111 may send the second message to the second third node 114, e.g., the UDR. In some examples, the second message may have a different content as the first message, that is, the first indication and the second indication. This may apply, for example, when the first node 111 may send the second message to the first third node 113, e.g., the PCF, the third third node 115, e.g., the SMF, and the fourth third node 116.

Initiating may be understood as triggering, starting, enabling or facilitating.

The first node 111 may send the second message directly, e.g., to the first third node 113 and/or the second third node 114 and/or the fifth third node 117.

The first node 111 may send the second message indirectly, e.g., to the third third node 115, e.g., via the first third node 113, and/or the fourth third node 116, e.g., via the first third node 113, and the third third node 115.

In some embodiments, the second message may be sent with the proviso the second node 112 is authorized in Action 402. For example, the first node 111, e.g., the NEF, may authorizes the request, stores it in the UDR and forward it to the PCF(s).

In some embodiments, the communications system 100 may be a 5G network and the first node 111 may be a NEF, the second node 112 may be an AF, and the one or more third nodes 113, 114, 115, 116, 117 may comprise one of: a PCF, a UDR, a UPF, a SMF and a node having a capability to perform machine-learning.

In other embodiments, the communications system 100 may be a 4G network, and the first node 111 may be a SCEF, the second node 112 may be an AS, or an SCS, and the one or more third nodes 113, 114, 115, 116, 117 may comprise one of: a PCRF, a SPR, a PGW-U, a TDF-U, a PGW-C or a TDF-C, and a node having a capability to perform machine-learning.

In some embodiments, at least one of the following may apply.

In some embodiments, the third node 113 may be one of a PCF or a PCRF, and the initiating 403 of the application of the indicated action may comprise triggering a rule indicating the action. When the first node 111 may be NEF, and may forward the second message to the PCF(s), there may be two cases. In case the PFD does not include UE IP address/es, e.g. it only includes IP addresses of servers under DDoS attack, there may be a need for a new node level procedure. In case the PFD may include the UE IP address/es, e.g., source IP addresses generating DDoS attacks, alone or together with IP addresses of servers under DDoS attack, an extension of the existing AF/NEF request for ongoing session, via Npcf_PolicyAuthorization, may be performed according to examples of embodiments herein.

In some embodiments, the third node 114 may be one of a UDR or an SPR, and the initiating 403 of the application of the indicated action may comprise storing information indicated in the first message.

In some embodiments, the third node 116 may be one of a UPF or an PGW-U or an TDF-U, and the initiating 403 of the application of the indicated action may comprise detecting traffic matching the second indication, and applying the action.

In some embodiments, the third node 115 may be one of a SMF or an PGW-C or an TDF-C, and the initiating 403 of the application of the indicated action may comprise triggering a rule indicating the action.

In some embodiments, the third node 117 may have a capability to perform machine-learning, and the initiating 403 of the application of the indicated action may comprise determining a model to predict or identify other DoS attacks.

In some embodiments, at least one of the one or more source nodes 122 of the DoS attack may be a UE.

In other embodiments, the second message is at least one of: a Npcf_Policy Request message, a Npcf_PolicyAuthorization Request message, and a Nudr_Store Request message.

Embodiments of a method performed by the third node 113, 114, 115, 116, 117 will now be described with reference to the flowchart depicted in FIG. 5. The method may be understood to be for handling a DoS attack. The third node 113, 114, 115, 116, 117 operates in the communications system 100.

The method may comprise the actions described below. In some embodiments all the actions may be performed. In some embodiments some of the actions may be performed. In FIG. 5, optional actions are indicated with a dashed box. One or more embodiments may be combined, where applicable. All possible combinations are not described to simplify the description. It should be noted that the examples herein are not mutually exclusive. Components from one example or embodiment may be tacitly assumed to be present in another example or embodiment and it will be obvious to a person skilled in the art how those components may be used in the other examples or embodiments.

The detailed description of some of the following corresponds to the same references provided above, in relation to the actions described for the first node 111 and will thus not be repeated here to simplify the description. For example, for embodiments wherein the action may be redirecting the traffic, the traffic may be redirected to another AS.

### Action 501

In this Action 501, the third node 113, 114, 115, 116, 117 receives the, directly or indirectly, from the first node 111 operating in the communications system 100, the second message. The second message indicates the identifier identifying the second node 112 operating outside of the communications system 100. The identifier may be, for example, the AF-ID. The first message also indicates the first indication indicating at least one of: i) the one or more target nodes 121 operating outside of the communications system 100 under DoS attack, and ii) the one or more source nodes 122 of the DoS attack, e.g., at least one of which may be a device 130. The second message further indicates the second indication indicating the action to be taken in the communications system 100 to mitigate the DoS attack.

The receiving in this Action 501 may be via the respective first link 151, and/or the second link 152 and the fifth link 155.

In some embodiments, the action may be at least one of: redirect traffic, block traffic, tear down connections, send traffic to an analytics engine, apply edge computing logic, and apply the authentication service.

The first indication may comprise at least one of: the one or more PFDs, and the one or more application identifiers.

In some embodiments, the first indication may comprise the respective IP address for each of the one or more source nodes 122.

In other embodiments, the first indication may lack the respective IP address for each of the one or more source nodes 122.

In some embodiments, the communications system 100 may be a 5G network and the first node 111 may be the NEF, the second node 112 may be the AF, and the one or more third nodes 113, 114, 115, 116, 117 may comprise one of: the PCF, the UDR, the UPF, the SMF and the node having the capability to perform machine-learning.

In other embodiments, the communications system 100 may be a 4G network, and the first node 111 may be the SCEF, the second node 112 may be the AS, or the SCS, and the one or more third nodes 113, 114, 115, 116, 117 may comprise one of: the PCRF, the SPR, the PGW-U, the TDF-U, the PGW-C or the TDF-C, and the node having the capability to perform machine-learning.

In some embodiments, the second message may be received with the proviso the second node 112 may have been authorized in Action 402.

### Action 502

In this Action 502, the third node 113, 114, 115, 116, 117 initiates an application of the indicated action in the communications system 100.

Initiating may be understood as triggering, starting, enabling or facilitating. In some embodiments, the third node 113 may be one of the PCF or the PCRF, and the initiating 502 of the application of the indicated action may comprise triggering the rule indicating the action. In some examples, the first third node 113, e.g., the PCF may trigger a rule including the list of PFD and the associated action, e.g., Mitigation-Action. As mentioned above, there may be two cases. In case the first indication, e.g., PFD may not include the respective IP address for each of the one or more source nodes 122, e.g., the UE IP address/es, e.g., it only includes the respective IP address for each of the one or more target nodes 121, e.g., the IP addresses of servers under DDoS attack, there may be a need for a new node level rule. In case the first indication, e.g., PFD, includes the respective IP address for each of the one or more source nodes 122, e.g., the UE IP address/es, e.g., the source IP addresses generating DDoS attacks, alone or together with the respective IP address for each of the one or more target nodes 121, an extension of the existing PCC rules may be needed for the ongoing session.

In some embodiments, the third node 114 may be one of the UDR or the SPR, and the initiating 502 of the application of the indicated action may comprise storing information indicated in the second message.

In some embodiments, the third node 116 may be one of the UPF or the PGW-U or the TDF-U, and the initiating 502 of the application of the indicated action may comprise detecting traffic matching the second indication, and applying the action. In some examples, the fourth third node 116, e.g., the UPF, may detect traffic matching the first indication, e.g., the list of PFD, and may apply the action, e.g., Mitigation-Action, e.g., redirect traffic towards a certain set of application servers.

In some embodiments, the third node 115 may be one of the SMF or the PGW-C or the TDF-C, and the initiating 502 of the application of the indicated action may comprise triggering the rule indicating the action. In some examples, the third third node 115, e.g., the SMF may translate the rules, received from the first third node 113, e.g., the PCF, towards the fourth third node 116, e.g., the UPF, as follows. In case the first indication, e.g., the PFD does not include the respective IP address for each of the one or more source nodes 122, e.g., the UE IP address/es, e.g., it only includes the respective IP address for each of the one or more target nodes 121, e.g., the IP addresses of servers under DDoS attack, a new Packet Flow Control Protocol (PFCP) node related security procedure may be needed, including the list of PFD and the associated action, e.g., Mitigation-Action. In case the first indication, e.g., the PFD includes the respective IP address for each of the one or more source nodes 122, e.g., the UE IP address/es, e.g., source IP addresses generating DDoS attacks, alone or together with the respective IP address for each of the one or more target nodes 121, e.g., the IP addresses of servers under DDoS attack, an extension of the existing PFCP Session Establishment/Modification procedure may be needed for the ongoing session, including the Packet Detection Rules (PDRs), with PFDs, and the associated action, e.g., Mitigation-Action.

In some embodiments, the third node 117 may have the capability to perform machine-learning, and the initiating 502 of the application of the indicated action may comprise determining the model to predict or identify other DoS attacks. By sending the second indication to the fifth third node 117, the network operator may learn patterns from the traffic and build a reputation system that may be used in later attacks. For example, the network operator may use patterns learnt from previous attacks to decide if suspicious traffic is or not attack-part. For example, the attacks may be often originated from some specific locations, the IoT devices may be more vulnerable, so they may be often hacked to be part of DDoS, some devices may be used before in an attack, etc. . . . The network operator may be understood to have a much higher visibility in the network than a single content provider, which may be understood to only have visibility on the subset of traffic directed to it, so the network operator may be able to use all the possible information. Again, two different cases may apply. In a first case, the second node 112 may send to the first node 111 the first indication, e.g., the PFDs, not including the respective IP address for each of the one or more source nodes 122, e.g., the UE IP address/es, e.g., source IP addresses generating DDoS attacks, it only includes the respective IP address for each of the one or more target nodes 121, e.g., the IP addresses of servers under DDoS attack. In a first case, the second node 112 may send to the first node 111 the first indication, e.g., the PFDs, including the respective IP address for each of the one or more source nodes 122, e.g., the UE IP address/es, e.g., source IP addresses generating DDoS attacks, alone or together with the respective IP address for each of the one or more target nodes 121, e.g., the IP addresses of servers under DDoS attack. Content Provider sends to MNO the PFDs NOT including UE IP address/es.

In some embodiments, at least one of the one or more source nodes 122 of the DoS attack may be the UE.

In some embodiments, at least one of the following may apply.

In other embodiments, the second message may be the Npcf_Policy Request message.

In other embodiments, the initiating in this Action 502 of the application of the indicated action may comprise sending a third message to another third node 115, 116. The third message may be one of: i) a Npcf_SMPolicyControl_Update Request message to the SMF, wherein the third node 113 is the PCF, ii) a PFCP Node Security Request message to the UPF, wherein the third node 115 is the SMF, and iii) a PFCP Session Modification Request message to the UPF, wherein the third node 115 is the SMF.

### Action 503

In this Action 503, the third node 116 may receive a fourth message from one of the one or more source nodes 122 of the DoS attack. In particular examples of this Action 503, the third node 116 may be the fifth third node 116, e.g., the UPF.

In some embodiments, initiating in Action 502 the application of the action may further comprise applying the action based on the received fourth message.

The receiving in this Action 503 may be via the respective third link 153.

In some embodiments, the fourth message may comprise the respective IP address of the one or more source nodes 122.

In other embodiments, the fourth message may lack the respective IP address for each of the one or more source nodes 122.

Embodiments of a computer-implemented method performed by the second node 112 will now be described with reference to the flowchart depicted in FIG. 6. The method may be understood to be for handling the DoS attack.

The method comprises the following action. One or more embodiments may be combined, where applicable. All possible combinations are not described to simplify the description. It should be noted that the examples herein are not mutually exclusive. Components from one example or embodiment may be tacitly assumed to be present in another example or embodiment, and it will be obvious to a person skilled in the art how those components may be used in the other examples.

The detailed description of some of the following corresponds to the same references provided above, in relation to the actions described for the first node 111 and will thus not be repeated here to simplify the description. For example, for embodiments wherein the action may be redirecting the traffic, the traffic may have to be redirected to another AS.

### Action 601

In this Action 601, the second node sends the first message to the first node 111 operating in a communications system 100. The second node 112 operates outside of the communications system 100.

The first message indicates the identifier identifying the second node 112. The identifier may be, for example, an AF-ID. The first message also indicates the first indication indicating at least one of: i) the one or more target nodes 121 operating outside of the communications system 100 under DoS attack, and ii) the one or more source nodes 122 of the DoS attack, e.g., at least one of which may be a device 130. The first message further indicates the second indication indicating the action to be taken in the communications system 100 to mitigate the DoS attack.

In some embodiments, the action may be at least one of: redirect traffic, block traffic, tear down connections, send traffic to the analytics engine, apply edge computing logic, and apply the authentication service.

The first indication may comprise at least one of: the one or more PFDs, and the one or more application identifiers.

In some embodiments, the first indication may comprise a respective internet protocol (IP) address for each of the one or more source nodes 122.

In other embodiments, the first indication may lack the respective IP address for each of the one or more source nodes 122.

In other embodiments, the first message may be a Nnef_Security Request message.

In some embodiments, the communications system 100 may be a 5G network and the first node 111 may be the NEF and the second node 112 may be the AF.

In other embodiments, the communications system 100 may be a 4G network, and the first node 111 may be the SCEF, and the second node 112 may be the AS, or the SCSg.

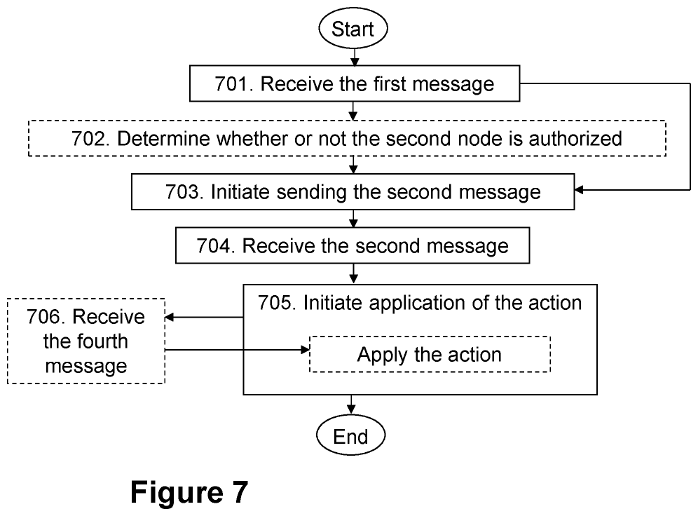

Embodiments of a method performed by the communications system 100, will now be described with reference to the flowchart depicted in FIG. 7. The method may be understood to be for handling the DoS attack. The communications system 100 comprises the first node 111 and the one or more third nodes 113, 114, 115, 116, 117.

The method may comprise the actions described below. In some embodiments, all the actions may be performed. In some embodiments some of the actions may be performed. In FIG. 7, optional actions are indicated with a dashed box. One or more embodiments may be combined, where applicable. All possible combinations are not described to simplify the description. It should be noted that the examples herein are not mutually exclusive. Components from one example or embodiment may be tacitly assumed to be present in another example or embodiment and it will be obvious to a person skilled in the art how those components may be used in the other examples or embodiments.

The detailed description of the Actions depicted in FIG. 7 may be understood to correspond to that already provided when describing the actions performed by each of the first node 111 and the one or more third nodes 113, 114, 115, 116, 117, and will therefore not be repeated here. For example, for embodiments wherein the action may be redirecting the traffic, the traffic may be redirected to another AS.

### Action 701

This Action 701, which corresponds to Action 401, comprises receiving, by the first node 111, from the second node 112 operating outside of the communications system 100, the first message. The first message indicates the identifier identifying the second node 112. The identifier may be, for example, an AF-ID. The first message also indicates the first indication indicating at least one of: i) the one or more target nodes 121 operating outside of the communications system 100 under DoS attack, and ii) the one or more source nodes 122 of the DoS attack, e.g., at least one of which may be a device 130. The first message further indicates the second indication indicating the action to be taken in the communications system 100 to mitigate the DoS attack.

In some embodiments, the action may be at least one of: redirect traffic, block traffic, tear down connections, send traffic to the analytics engine, apply edge computing logic, and apply the authentication service. The analytics engine may be, e.g., the fifth third node 117.

The first indication may comprise at least one of: the one or PFDs, and one or more application identifiers.

In some embodiments, the first indication may comprise the respective IP address for each of the one or more source nodes 122.

In other embodiments, the first indication may lack the respective IP address for each of the one or more source nodes 122.

In other embodiments, the first message may be the Nnef_Security Request message.

In some embodiments, the communications system 100 may be a 5G network and the first node 111 may be the NEF, the second node 112 may be the AF, and the one or more third nodes 113, 114, 115, 116, 117 may comprise one of: the PCF, the UDR, the UPF, the SMF and the node having the capability to perform machine-learning.

In other embodiments, the communications system 100 may be a 4G network, and the first node 111 may be the SCEF, the second node 112 may be the AS, or the SCS, and the one or more third nodes 113, 114, 115, 116, 117 may comprise one of: the PCRF, the SPR, the PGW-U, the TDF-U, the PGW-C or the TDF-C, and the node having the capability to perform machine-learning.

### Action 702

In this Action 702, which corresponds to Action 042, the method may comprise determining, by the first node 111, whether or not the second node 112 may be authorized to request the action to be taken. This Action 702 is optional, as indicated by the direct arrow from Action 701 to Action 703 in FIG. 7. Nevertheless, from a security perspective, it may be understood to be advantageous to perform Action 702, as indicated by the arrows between Action 701->Action 702->Action 703 in FIG. 7.

### Action 703

In this Action 703, which corresponds to Action 403, the method may comprise initiating 704 sending, directly or indirectly, by the first node 111, the second message to the one of one or more third nodes 113, 114, 115, 116, 117 operating in the communications system 100.

The second message is based on the received first message. The second message initiates the application of the indicated action in the communications system 100.

The second message may indicate at least one of: a) the identifier, the first indication and the second indication, and b) the first indication and the second indication.

In some embodiments, the second message may be sent with the proviso the second node 112 is authorized in Action 402.

In some embodiments, at least one of the following may apply.

In some embodiments, the third node 114 may be one of the UDR or the SPR, and the initiating 703a, 403 of the application of the indicated action may comprise storing information indicated in the first message.

In some embodiments, the third node 113 may be one of the PCF or the PCRF, and the initiating 703, 403 of the application of the indicated action may comprise triggering the rule indicating the action.

In some embodiments, the third node 115 may be one of the SMF or the PGW-C or the TDF-C, and the initiating 703, 403 of the application of the indicated action may comprise triggering the rule indicating the action.

In some embodiments, the third node 116 may be one of the UPF or the PGW-U or the TDF-U, and the initiating 703, 403 of the application of the indicated action may comprise detecting the traffic matching the second indication, and applying the action.

In some embodiments, the third node 117 may have the capability to perform machine-learning, and the initiating 703, 403 of the application of the indicated action may comprise determining the model to predict or identify other DoS attacks.

In some embodiments, at least one of the one or more source nodes 122 of the DoS attack may be the UE.

In other embodiments, the second message may be at least one of: the Npcf_Policy Request message, the Npcf_PolicyAuthorization Request message, and the Nudr_Store Request message.

### Action 704

In this Action 704, which corresponds to Action 501, the method comprises receiving, directly or indirectly, by the one of one or more third nodes 113, 114, 115, 116, 117, from the first node 111, the second message.

The receiving in this Action 704, may be performed via a respective first link 151, and/or the second link 152.

### Action 705

In Action 705, which corresponds to Action 502, the method comprises initiating, by the one of one or more third nodes 113, 114, 115, 116, 117, an application of the indicated action in the communications system 100.

The receiving in this Action 705, may be performed via the third link 153.

### Action 706

In some embodiments, in this Action 706, which corresponds to Action 503, the method may comprise receiving, by the one of one or more third nodes 116, the fourth message from the one of the one or more source nodes 122 of the DoS attack.

In some embodiments, the initiating in Action 705, 502 of the application of the action may further comprise applying the action based on the received fourth message.

The receiving in this Action 503 may be via the respective third link 153.

In some embodiments, the fourth message may comprise the respective IP address of the one or more source nodes 122.

In other embodiments, the fourth message may lack the respective IP address for each of the one or more source nodes 122.

The methods just described as being implemented by the first node 111, the second node 112, the one or more third nodes 113, 114, 115, 116, 117 and the communications system 100 will now be described in further detail with two specific non-limiting examples in the next two figures.

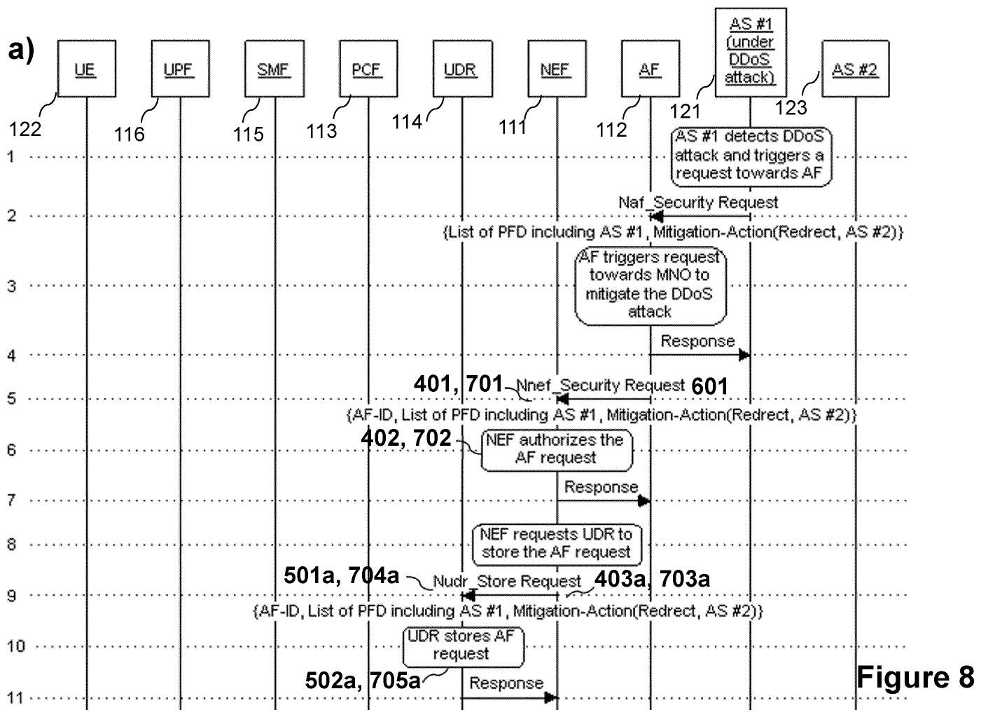

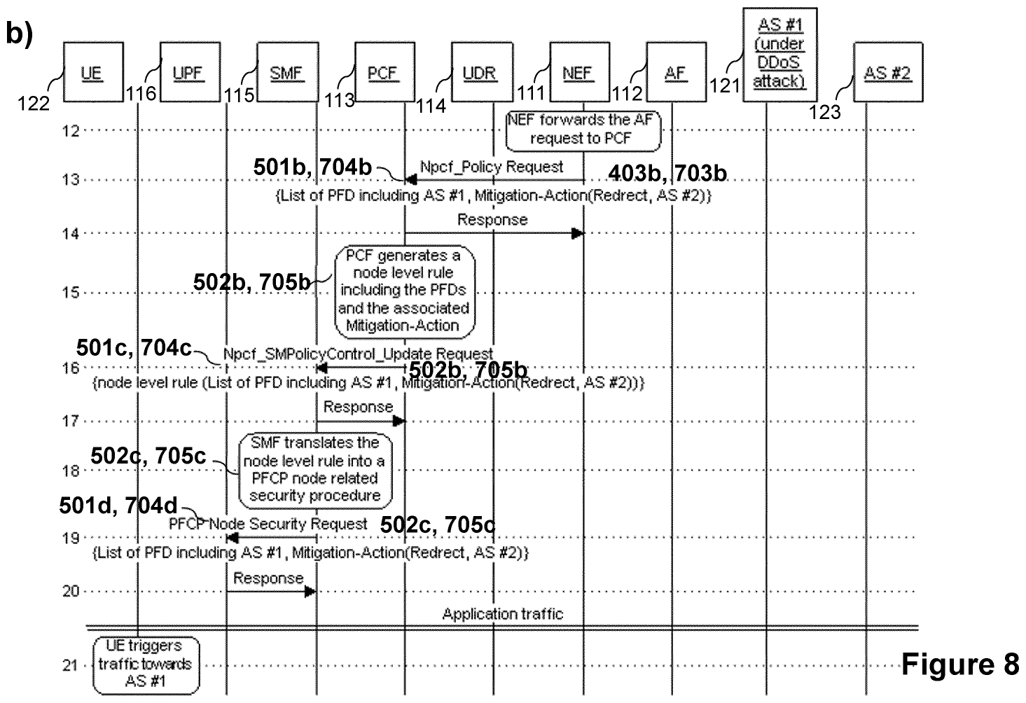

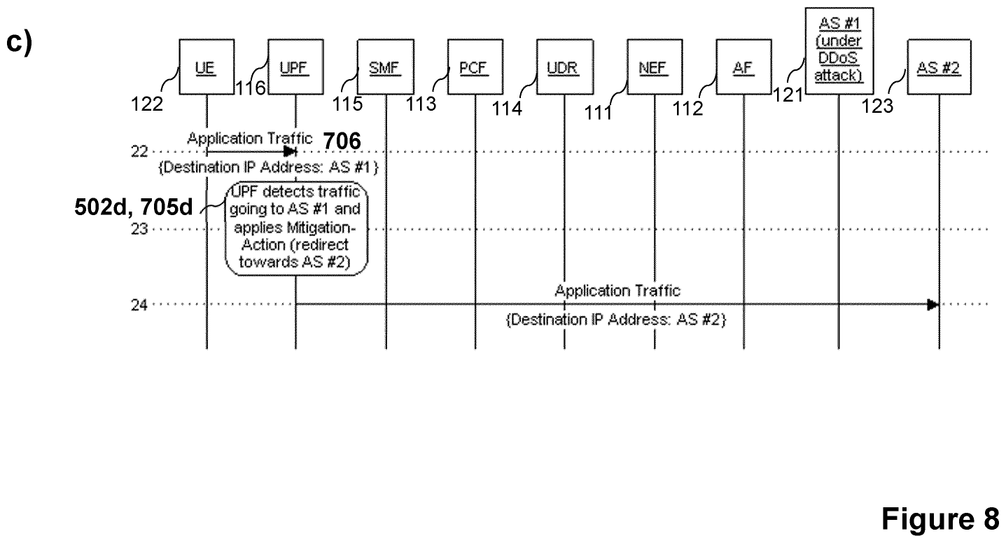

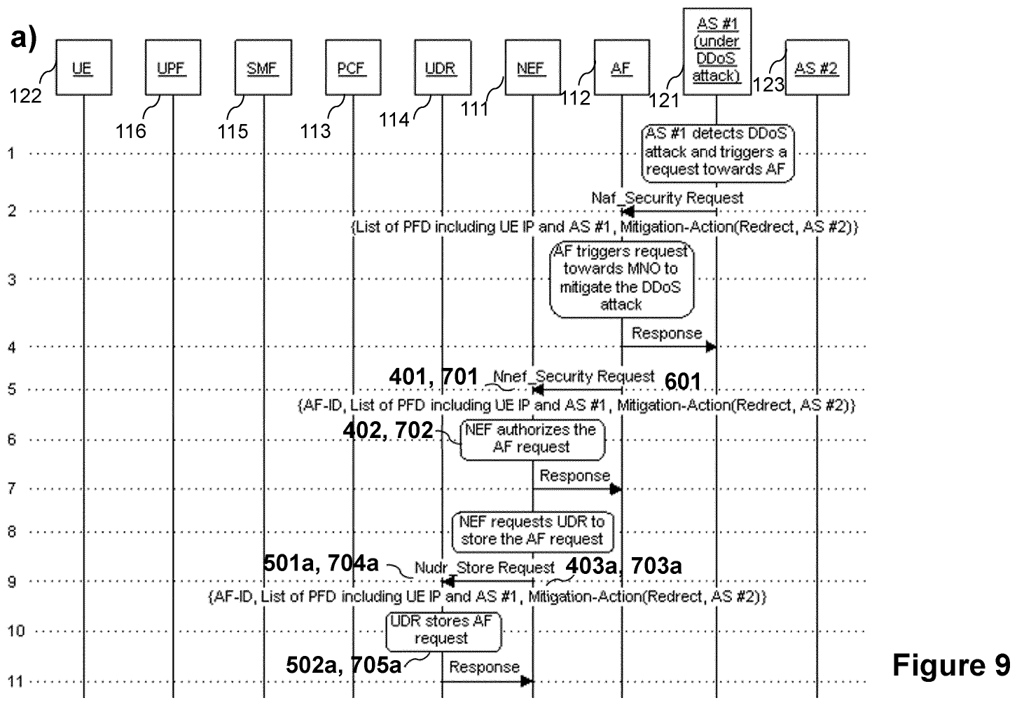

FIG. 8 is a sequence diagram depicting, along panels a), b) and c), a first non-limiting example on the method performed by the communications system 100, described in embodiments herein for the example use case when the content provider detects a DDoS attack, e.g., to the one or more target nodes 121, e.g., the servers in a certain geographical site, and requests MNO, via the first node 111, to redirect the application traffic going originally to the servers under DDoS attack towards other servers 123, e.g., in another geographical site. The steps of this example are detailed below. In this non-limiting example, the first node 111 is a NEF, the second node 112 is an AF, the first third node 113 is a PCF, the second third node 114 is a UDR, the third third node 115 is an SMF, the fourth third node 116 is a UPF, a target node 121 is a first Application Server (AS #1), the other server 123 is another AS (AS #2), and the source node 122 is a UE. In this example, in Step 1, the content provider, e.g., AS #1, but it may also be a Firewall at the content provider's side, detects a DDoS attack and in Step 2, triggers a request towards the second node 112, the content provider's AF. This is internal signaling at the content provider's side. The AS triggers towards the second node 112 a Naf_Security Request message including the following parameters: the first indication comprising List of PFDs including AS #1, and the second indication indicating the Mitigation-Action. This parameter indicates the action to be applied to the traffic matching the list of PFD. In this example, it includes: Redirect, which indicates the action is to redirect traffic, and AS #2, so traffic is to be redirected to AS #2. In Steps 3 to 5, based on the message received at step 2 above, the second node 112, in accordance to Action 601, triggers the first message as a request towards the first node 111 to mitigate the DDoS attack with a new Nnef API/service, e.g., Nnef_Security, and AF to trigger a Nnef_Security Request message, including the following parameters: the identifier as the AF-ID, which identifies the second node 112, the first indication as the List of PFDs including AS #1, and the second indication as Mitigation-Action. This parameter indicates the action to be applied to the traffic matching the list of PFD. In this example, it includes: Redirect, which indicates the action is to redirect traffic, and AS #2, so traffic is to be redirected to AS #2. The first node 111 receives the first message in accordance with Action 401, 701. In Steps 6 and 7, the first node 111, in accordance with Action 402, 702, authorizes the AF request, and answers the second node 112 indicating successful operation. In Steps 8 and 9, the first node 111, in accordance with a first variant of Action 403, 703 referred to herein as Action 403a, 703, requests the second third node 114 to store the AF request, by triggering a Nudr_Store Request message including the information received in Step 2 above. This is received by the second third node 114 in accordance with a first variant of Action 501, 704 referred to herein as Action 501a, 704a. In Steps 10 and 11, the second third node 114, in accordance with a first version of Action 502, 705, referred to herein as Action 502a, 705a, stores the AF request and answers to the first node 111 indicating successful operation. Continuing on panel b), in Steps 12 and 13, in accordance with a second variant of Action 403, 703 referred to herein as Action 403b, 703b, the first node 111 forwards the AF request to the first third node 113 by triggering the second message as a Npcf_Policy Request message including the following parameters: the first indication as the List of PFDs including AS #1, and the second indication as the Mitigation-Action. This indicates the action to be applied to the traffic matching the list of PFD. In this example, it includes: Redirect, which indicates the action is to redirect traffic, and AS #2, so traffic is to be redirected to AS #2. The first third node 113 receives the second message in a second variant of Action 501, 704, referred to herein as Action 501b, 704b. In Step 14, the first third node 113 answers to the first node 111 indicating successful operation. In Steps 15 and 16, the first node 111, in agreement with a second version of Action 502, 705 referred to herein as Action 502b, 705b, generates a node level rule including the PFDs and the associated Mitigation-Action and triggers the third message as a Npcf_SMPolicyControl_Update Request message towards the third third node 115, including the following parameters: Node level rule, including: the first indication as the List of PFDs including AS #1, and the second indication as the Mitigation-Action. This parameter indicates the action to be applied to the traffic matching the list of PFD. In this example, it includes: Redirect, which indicates the action is to redirect traffic, and AS #2, so traffic is to be redirected to AS #2. In the example sequence diagram of FIG. 8, it is assumed the PFD does not include the client IP and port, as source of DDoS attack. That is, in FIG. 8, the PFD may comprise 3 tuples, including: Server IP address, including AS #1 IP address, as the target of the DDoS attack, optionally server port, e.g., port 80 or 8080 for HTTP traffic, and optionally, IP protocol, e.g., TCP protocol. Alternatively, in case the PFDs may comprise 5-tuples, e.g., including both, the respective IP address for each of the one or more target nodes 121, that is, network entity/ies under DDoS attack and the respective IP address for each of the one or more source nodes 122, that is, network entity/ies being the source of the DDoS attack, e.g., PFDs including source A.B.C.D/X and destination being a set of a movie streaming application server sites, each PFD may comprise: Server IP address, including AS #1 IP address, as the target of the DDoS attack, Server port, e.g. port 80 or 8080 for HTTP traffic, IP protocol, e.g., TCP protocol, Client (UE) IP address, which identifies the source/s of the DDoS attack, and Client (UE) port. In this case, there may be no need for a new node level rule. The third third node 115 receives the third message in accordance with a third version of Action 501, 704, referred to herein as Action 501c, 704c. In Step 17, the third third node 115 answers to the first third node 113 indicating successful operation. In Steps 18 and 19, the third third node 115, in agreement with a third version of Action 502, 705 referred to herein as Action 502c, 705c, translates the node level rule into a new PFCP node related security procedure, by triggering a PFCP Node Security Request message including the following parameters: the first indication as the List of PFDs including AS #1, and the second indication as the Mitigation-Action, which indicates the action to be applied to the traffic matching the list of PFD. In this example, it comprises Redirect, which indicates the action is to redirect traffic, and AS #2, so traffic is to be redirected to AS #2. As indicated in Steps 15 and 16 above, in case the PFDs comprises 5-tuples, including both network entity/ies under DDoS attack and network entity/ies being the source of the DDoS attack, there may be no need for a new PFCP node related security procedure. The fourth third node 116 receives the request in agreement with a fourth variant of Action 501, 704, referred to herein as Action 501d, 704d. In Step 20, the fourth third node 116 answers to the third third node 115 indicating successful operation. In Steps 21 and, continuing in panel c), Step 22, the source node 122 triggers traffic towards the target node 121, AS #1, which the fourth third node 116 receives according to Action 706. In Steps 23 and 24, the fourth third node 116 detects traffic going to the target node 121, the AS #1, and according to a fourth version of Action 502, 705, referred to herein as Action 502d, 705d, applies the Mitigation-Action, that is, redirect towards AS #2.

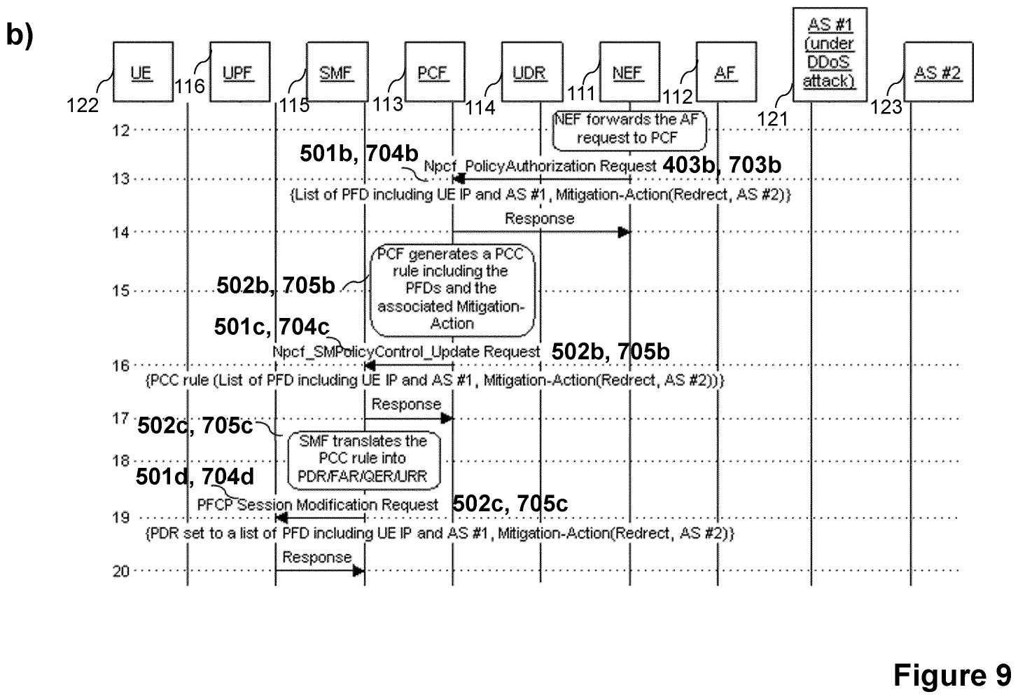

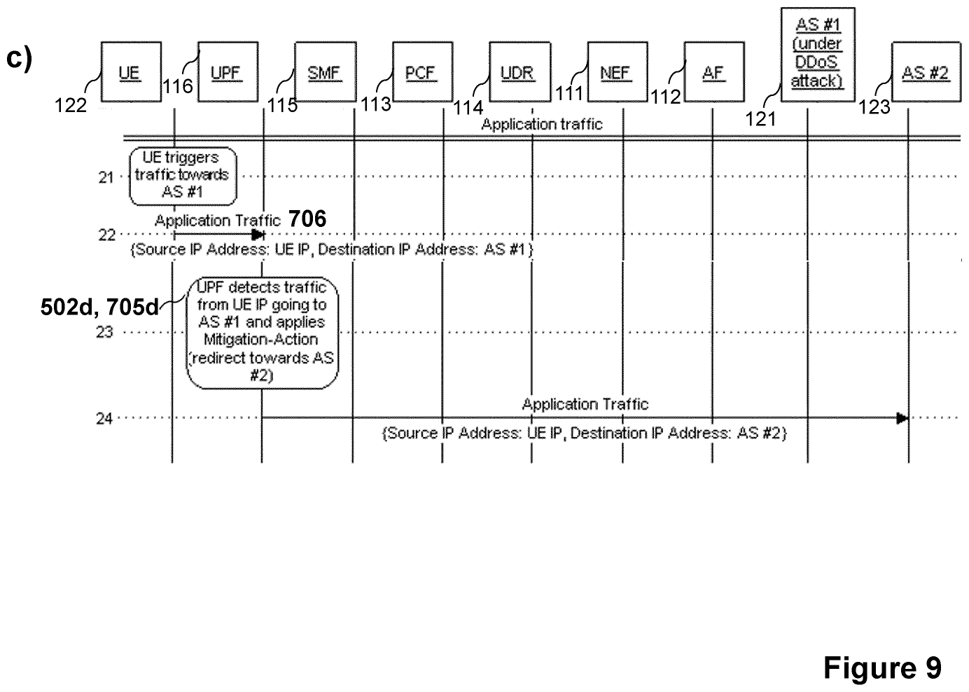

FIG. 9 is a sequence diagram depicting, along panels a), b) and c), a second non-limiting example on the method performed by the communications system 100, described in embodiments herein, wherein the content provider sends to the MNO the PFDs including UE IP address/es. The non-limiting example of the method performed by the communications system 100 is per session, for the example use case when the content provider detects a DDoS attack from the respective IP address for each of the one or more source nodes 122, that is, source IP address/es generating DDoS attacks, alone or together with the respective IP address for each of the one or more target nodes 121, that is, the IP addresses of servers under DDoS attack in a certain geographical site, and requests the MNO, via the first node 111, to redirect the application traffic going originally to the servers under DDoS attack towards other servers 123, e.g., in another geographical site. The steps of this example are detailed below. In this non-limiting example, the first node 111 is a NEF, the second node 112 is an AF, the first third node 113 is a PCF, the second third node 114 is a UDR, the third third node 115 is an SMF, the fourth third node 116 is a UPF, a target node 121 is a first Application Server (AS #1), the other server 123 is another AS (AS #2), and the source node 122 is a UE. In this example, in Step 1, the content provider, e.g., AS #1, but it may also be a Firewall at the content provider's side, detects a DDoS attack and in Step 2, triggers a request towards the second node 112, the content provider's AF. This is internal signaling at the content provider's side. The AS triggers towards the second node 112 a Naf_Security Request message including the following parameters: the first indication comprising List of PFDs including AS #1, and the second indication indicating the Mitigation-Action. This parameter indicates the action to be applied to the traffic matching the list of PFD. In this example, it includes: Redirect, which indicates the action is to redirect traffic, and AS #2, so traffic is to be redirected to AS #2. In Steps 3 to 5, based on the message received at step 2 above, the second node 112, in accordance to Action 601, triggers the first message as a request towards the first node 111 to mitigate the DDoS attack with a new Nnef API/service, e.g., Nnef_Security, and AF to trigger a Nnef_Security Request message, including the following parameters: the identifier as the AF-ID, which identifies the second node 112, the first indication as the List of PFDs including AS #1, and the second indication as Mitigation-Action. This parameter indicates the action to be applied to the traffic matching the list of PFD. In this example, it includes: Redirect, which indicates the action is to redirect traffic, and AS #2, so traffic is to be redirected to AS #2. The first node 111 receives the first message in accordance with Action 401, 701. In Steps 6 and 7, the first node 111, in accordance with Action 402, 702, authorizes the AF request, and answers the second node 112 indicating successful operation. In Steps 8 and 9, the first node 111, in accordance with a first variant of Action 403, 703 referred to herein as Action 403a, 703a, requests the second third node 114 to store the AF request, by triggering a Nudr_Store Request message including the information received in Step 2 above. This is received by the second third node 114 in accordance with a first variant of Action 501, 704 referred to herein as Action 501a, 704a. In Steps 10 and 11, the second third node 114, in accordance with a first version of Action 502, 705, referred to herein as Action 502a, 705a, stores the AF request and answers to the first node 111 indicating successful operation. Continuing on panel b), in Steps 12 and 13, in accordance to a second variant of Action 403, 703 referred to herein as Action 403b, 703b, the first node 111 forwards the AF request to the first third node 113 by triggering the second message as a Npcf_PolicyAuthorization Request message including the following parameters: the first indication as the List of PFDs including the respective IP address for of the source node 122 as the UE IP and the respective IP address for the target node 121, that is, AS #1, and the second indication as the Mitigation-Action. This indicates the action to be applied to the traffic matching the list of PFD. In this example, it includes: Redirect, which indicates the action is to redirect traffic, and AS #2, so traffic is to be redirected to AS #2. The first third node 113 receives the second message in a second variant of Action 501, 704, referred to herein as Action 501b, 704b. In Step 14, the first third node 113 answers to the first node 111 indicating successful operation. In Steps 15 and 16, the first node 111, in agreement with a second version of Action 502, 705 referred to herein as Action 502b, 705b, generates a PCC rule including the PFDs and the associated Mitigation-Action and triggers the third message as a Npcf_SMPolicyControl_Update Request message towards the third third node 115, including the following parameters: the PCC rule, including: the first indication as the List of PFDs including the respective IP address for of the source node 122 as the UE IP and the respective IP address for the target node 121, that is, AS #1, and the second indication as the Mitigation-Action. This parameter indicates the action to be applied to the traffic matching the list of PFD. In this example, it includes: Redirect, which indicates the action is to redirect traffic, and AS #2, so traffic is to be redirected to AS #2. In the example sequence diagram of FIG. 9, it is assumed the PFD includes the UE IP address and possibly also the UE port, as source of DDoS attack and also AS #1, as the server/s under DDoS attack. That is, in FIG. 8, the PFD may comprise 5 tuples, e.g., including both, the respective IP address for each of the one or more target nodes 121, that is, network entity/ies under DDoS attack and the respective IP address for each of the one or more source nodes 122, that is, network entity/ies being the source of the DDoS attack, e.g., PFDs including source A.B.C.D/X and destination being a set of a movie streaming application server sites, each PFD may comprise: Server IP address, including AS #1 IP address, as the target of the DDoS attack, Server port, e.g. port 80 or 8080 for HTTP traffic, IP protocol, e.g., TCP protocol, Client (UE) IP address, which identifies the source/s of the DDoS attack, and Client (UE) port. In this case, the existing, per session, PCC rules may be reused, extended to convey the Mitigation-Action. The third third node 115 receives the third message in accordance with a third version of Action 501, 704, referred to herein as Action 501c, 704c. In Step 17, the third third node 115 answers to the first third node 113 indicating successful operation. In Steps 18 and 19, the third third node 115, in agreement with a third version of Action 502, 705 referred to herein as Action 502c, 705c, translates the PCC rule into PDR/Forwarding Action Rule (FAR)/QER/Usage Reporting Rule (URR) within a PFCP per session procedure, by triggering a PFCP Session Modification Request message including the following parameters: the first indication as the List of PFDs including the respective IP address for of the source node 122 as the UE IP and the respective IP address for the target node 121, that is, AS #1, and the second indication as the Mitigation-Action, which indicates the action to be applied to the traffic matching the list of PFD. In this example, it comprises Redirect, which indicates the action is to redirect traffic, and AS #2, so traffic is to be redirected to AS #2. As indicated in Steps 15 and 16 above, in case the PFDs comprises 5-tuples, including both network entity/ies under DDoS attack and network entity/ies being the source of the DDoS attack, the existing PFCP per session procedures may be reused, extended to convey the Mitigation-Action. The fourth third node 116 receives the request in agreement with a fourth variant of Action 501, 704, referred to herein as Action 501d, 704d. In Step 20, the fourth third node 116 answers to the third third node 115 indicating successful operation. Continuing in panel c), in Steps 21 and Step 22, the source node 122 triggers traffic, e.g., multiple UL TCP SYN messages, from the respective IP address for of the source node 122 as the UE IP towards the target node 121, AS #1, which the fourth third node 116 receives according to Action 706. In Steps 23 and 24, the fourth third node 116 detects traffic going to from the respective IP address for of the source node 122 as the UE IP the target node 121, the AS #1, and according to a fourth version of Action 502, 705, referred to herein as Action 502d, 705d, applies the Mitigation-Action, that is, redirect towards AS #2. Although not depicted in FIG. 9, other devices or nodes than the one or more source nodes 122 may also be exchanging traffic with the one or more target nodes 121, e.g., streaming movies from AS #1. Embodiments herein may be understood to enable that, in another example of embodiments herein, if the one or more source nodes 122, e.g., the device 130, are listed or indicated in the first indication, e.g., the PFD, as the one or more source nodes 122 being responsible for the DoS attack, then, the action, e.g., the blocking of traffic and/or tear down of connection mitigation action, may be applied to these one or more source nodes 122, but may, or may not be applied to other nodes, e.g., UEs. That is, traffic from other UEs not indicated in the first indication, e.g., not listed in the PFD, may be transferred to AS #2 to offload AS #1 being under attack, in some examples. However, in other examples, a mitigation action for the one or more source nodes 122 being specified in the first indication, e.g., the PFD, may apply, e.g., block traffic, tear down connection to these one or more source nodes 122, whereas for other nodes or devices not specified in the first indication, that is in the PFD, other mitigation action(s) may be applied. For example, they may be moved to another AS. This may ensure that the content provider may continue to provide service to nodes or devices not involved in the attack. It may be understood that this general principle of different treatment of nodes, e.g., UEs, triggering traffic does not only refer to the particular non-limiting example depicted in FIG. 9, but may be applied to all embodiments herein, provided that the one or more source nodes 122 of the DoS attack may be indicated in the respective first indication, e.g. in the PFD, such that a first mitigation action may be applied to those indicated one or more source nodes 122, and a second mitigation action may be applied to those other nodes being not indicated in the first indication, e.g., the PFD.

As mentioned earlier, the embodiments described herein, do not only apply to 5G network architecture, but the same mechanisms may be applied to 4G, just by replacing: AF by SCS/AS, NEF by SCEF, PCF by PCRF, UDR by SPR, SMF by PGW-C or TDF-C and UPF by PGW-U or TDF-U.

One advantage of embodiments herein is that they may allow an operator of the network to help content providers to mitigate DoS, e.g., DDoS attacks, as network resources may be understood to be usually larger than those of content providers, by ensuring that only legitimate requests may reach the service providers sites.

Another advantage of embodiments herein is that they may allow that an MNO may offer a firewall as an open platform to content providers, so that the more scalable firewall functions of the MNO may be outsourced to the MNO by the content provider. As a further advantage, content providers may refuse to encrypt the SNI or may facilitate traffic detection rules to the MNO in this collaborative scenario.

One further advantage of embodiments herein is that they may allow that an MNO may help a content provider to keep a service alive, and to mitigate the attack using the redirection capacity and its geo redundancy Content Delivery Networks (CDNs). Embodiments herein may provide the mitigation by balancing the traffic-attack to other locations, or by blocking directly from the network before an attack-traffic may reach the servers.

Yet another advantage of embodiments herein is that they may allow to convey firewall policies for service providers sites, through a new exposure API for sending the firewall rules to apply from the application servers to the network providers, e.g., deny traffic when a source may be A.B.C.D/X and a destination may be a Movie streaming application site.

One further advantage of embodiments herein is that they may allow load balancing and scalation capabilities, through a new exposure API for requesting load balancing to the network, e.g., servers of a Movie streaming application in the USA are under attack and the Movie streaming application may request the network to redirect part of the traffic to other geographical sites.

Embodiments herein may also be understood to work even when the traffic is encrypted, e.g. DNS encryption and/or HTTPS (TLS) or QUIC based applications.

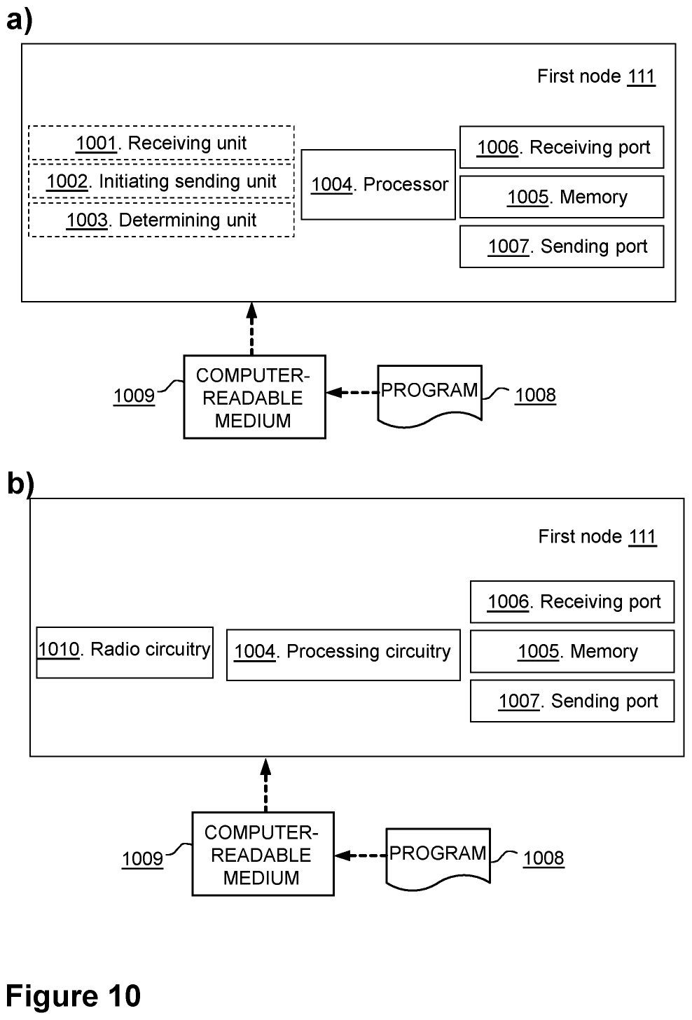

FIG. 10 depicts two different examples in panels a) and b), respectively, of the arrangement that the first node 111 may comprise to perform the method actions described above in relation to FIG. 4, FIG. 7, and/or FIGS. 8-9. In some embodiments, the first node 111 may comprise the following arrangement depicted in FIG. 10a. The first node 111 may be understood to be for handling the DoS attack. The first node 111 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 10, optional boxes are indicated by dashed lines. The detailed description of some of the following corresponds to the same references provided above, in relation to the actions described for the first node 111 and will thus not be repeated here. For example, for embodiments wherein the action may be redirecting the traffic, the traffic may be redirected to another AS.

The first node 111 is configured to, e.g. by means of a receiving unit 1001 within the first node 111 configured to, receive, from the second node 112 configured to operate outside of the communications system 100, the first message configured to indicate: i) the identifier configured to identify the second node 112, ii) the first indication configured to indicate at least one of: i) the one or more target nodes 121 configured to operate outside of the communications system 100 under DoS attack, and ii) the one or more source nodes 122 of the Dos attack, and iii) the second indication configured to indicate the action to be taken in the communications system 100 to mitigate the DoS attack.

The first node 111 is further configured to, e.g. by means of an initiating sending unit 1002 within the first node 111 configured to, initiate sending, directly or indirectly, the second message to the one of one or more third nodes 113, 114, 115, 116, 117 configured to operate in the communications system 100. The second message is configured to be based on the first message configured to be received. The second message is configured to initiate the application of the action in the communications system 100 configured to be indicated.

In some embodiments the second message may be configured to indicate at least one of: a) the identifier, the first indication and the second indication, and b) the first indication and the second indication.

In some embodiments, the action may be configured to be at least one of: redirect traffic, block traffic, tear down connections, send traffic to the analytics engine, apply edge computing logic, and apply an authentication service.

In some embodiments, the first indication may be configured to comprise at least one of: the one or more PPFDs, and the one or more application identifiers.

In some embodiments, the first indication may be configured to comprise the respective IP address for each of the one or more source nodes 122.

In some embodiments, the first indication may be configured to lack the respective IP address for each of the one or more source nodes 122.

The first node 111 may also be configured to, e.g. by means of a determining unit 1003 within the first node 111 configured to, determine whether or not the second node 112 may be authorized to request the action to be taken. In such embodiments, the second message may be configured to be sent with the proviso the second node 112 is authorized.

In some embodiments, one of the following may apply. In some embodiments, the communications system 100 may be configured to be a 5G network, and: the first node 111 may be configured to be the NEF, the second node 112 may be configured to be the AF, and the one or more third nodes 113, 114, 115, 116, 117 may be configured to comprise one of: the PCF, the UDR, the UPF, the SMF, and the node having the capability to perform machine-learning. In some embodiments, the communications system 100 may be configured to be a 4, network, and: the first node 111 may be configured to be the SCEF, the second node 112 may be configured to be the AS, or the SCS, and the one or more third nodes 113, 114, 115, 116, 117 may be configured to comprise one of: the PCRF, the SPR, the PGW-U, the TDF-U, the PGW-C or the TDF-C, and the node having the capability to perform machine-learning.

In some embodiments, at least one of the following may apply. In some embodiments, the third node 113 may be configured to be one of the PCF or the PCRF, and the initiating of the application of the indicated action may be configured to comprise triggering the rule indicating the action. In some embodiments, the third node 114 may be configured to be one of the UDR or the SPR, and the initiating of the application of the indicated action may be configured to comprise storing information indicated in the first message. In some embodiments, the third node 116 may be configured to be one of the UPF or the PGW-U or the TDF-U, and the initiating of the application of the indicated action may be configured to comprise detecting traffic matching the second indication, and applying the action. In some embodiments, the third node 115 may be configured to be one of the SMF or the PGW-C or the TDF-C, and the initiating of the application of the indicated action may be configured to comprise triggering the rule indicating the action. In some embodiments, the third node 117 may be configured to have the capability to perform machine-learning, and the initiating of the application of the indicated action may be configured to comprise determining the model to predict or identify other DoS attacks. In some embodiments, at least one of the one or more source nodes 122 of the DoS attack may be configured to be the UE.

In some embodiments, at least one of the following may apply. In some embodiments, the first message may be configured to be the Nnef_Security Request message, and the second message may be configured to be at least one of: the Npcf_Policy Request message, the Npcf_PolicyAuthorization Request message, and the Nudr_Store Request message.

The embodiments herein may be implemented through one or more processors, such as a processor 1004 in the first node 111 depicted in FIG. 10, together with computer program code for performing the functions and actions of the embodiments herein. The program code mentioned above may also be provided as a computer program product, for instance in the form of a data carrier carrying computer program code for performing the embodiments herein when being loaded into the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 1005 comprising one or more memory units. The memory 1005 is arranged to be used to store obtained information, store data, configurations, schedulings, and applications etc. to perform the methods herein when being executed in the first node 111.

In some embodiments, the first node 111 may receive information from, e.g., the second node 112, the third node 113, 114, 115, 116, 117, the one or more source nodes 122, the one or more target nodes 122 and/or another structure in the communications system 100 through a receiving port 1006. In some examples, the receiving port 1006 may be, for example, connected to one or more antennas in the first node 111. In other embodiments, the first node 111 may receive information from another structure in the communications system 100 through the receiving port 1006. Since the receiving port 1006 may be in communication with the processor 1004, the receiving port 1006 may then send the received information to the processor 1004. The receiving port 1006 may also be configured to receive other information.

The processor 1004 in the first node 111 may be further configured to transmit or send information to e.g., the second node 112, the third node 113, 114, 115, 116, 117, the one or more source nodes 122, the one or more target nodes 122 and/or another structure in the communications system 100, through a sending port 1007, which may be in communication with the processor 1004, and the memory 1005.

Those skilled in the art will also appreciate that any of the units 1001-1003 described above may refer to a combination of analog and digital circuits, and/or one or more processors configured with software and/or firmware, e.g., stored in memory, that, when executed by the one or more processors such as the processor 1004, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1001-1003 described above may be the processor 1004 of the first node 111, or an application running on such processor.

Thus, the methods according to the embodiments described herein for the first node 111 may be respectively implemented by means of a computer program 1008 product, comprising instructions, i.e., software code portions, which, when executed on at least one processor 1004, cause the at least one processor 1004 to carry out the actions described herein, as performed by the first node 111. The computer program 1008 product may be stored on a computer-readable storage medium 1009. The computer-readable storage medium 1009, having stored thereon the computer program 1008, may comprise instructions which, when executed on at least one processor 1004, cause the at least one processor 1004 to carry out the actions described herein, as performed by the first node 111. In some embodiments, the computer-readable storage medium 1009 may be a non-transitory computer-readable storage medium, such as a CD ROM disc, a memory stick, or stored in the cloud space. In other embodiments, the computer program 1008 product may be stored on a carrier containing the computer program, wherein the carrier is one of an electronic signal, optical signal, radio signal, or the computer-readable storage medium 1009, as described above.

The first node 111 may comprise an interface unit to facilitate communications between the first node 111 and other nodes or devices, e.g., the second node 112, the third node 113, 114, 115, 116, 117, the one or more source nodes 122, the one or more target nodes 122 and/or another structure in the communications system 100. In some particular examples, the interface may, for example, include a transceiver configured to transmit and receive radio signals over an air interface in accordance with a suitable standard.

In other embodiments, the first node 111 may comprise the following arrangement depicted in FIG. 10b. The first node 111 may comprise a processing circuitry 1004, e.g., one or more processors such as the processor 1004, in the first node 111 and the memory 1005. The first node 111 may also comprise a radio circuitry 1010, which may comprise e.g., the receiving port 1006 and the sending port 1007. The processing circuitry 1004 may be configured to, or operable to, perform the method actions according to FIG. 4, FIG. 7, and/or FIGS. 8-9, in a similar manner as that described in relation to FIG. 10a. The radio circuitry 1010 may be configured to set up and maintain at least a wireless connection with the second node 112, the third node 113, 114, 115, 116, 117, the one or more source nodes 122, the one or more target nodes 122 and/or another structure in the communications system 100.

Hence, embodiments herein also relate to the first node 111 operative to handle the DoS attack, the first node 111 being operative to operate in the communications system 100. The first node 111 may comprise the processing circuitry 1004 and the memory 1005, said memory 1005 containing instructions executable by said processing circuitry 1004, whereby the first node 111 is further operative to perform the actions described herein in relation to the first node 111, e.g., in FIG. 4, FIG. 7, and/or FIGS. 8-9.

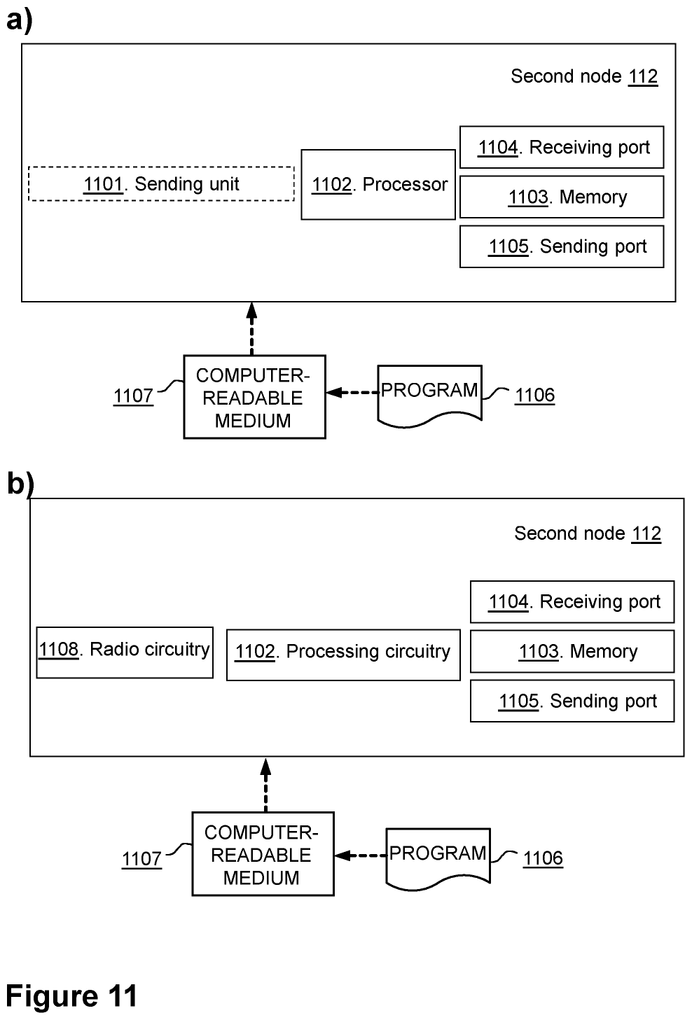

FIG. 11 depicts two different examples in panels a) and b), respectively, of the arrangement that the second node 112 may comprise to perform the method actions described above in relation to FIG. 6, FIG. 7, and/or FIGS. 8-9. In some embodiments, the second node 112 may comprise the following arrangement depicted in FIG. 11a. The second node 112 may be understood to be for handling the DoS attack.

Several embodiments are comprised herein. Components from one embodiment may be tacitly assumed to be present in another embodiment and it will be obvious to a person skilled in the art how those components may be used in the other exemplary embodiments. In FIG. 11, optional boxes are indicated by dashed lines. The detailed description of some of the following corresponds to the same references provided above, in relation to the actions described for the second node 112 and will thus not be repeated here. For example, for embodiments wherein the action may be redirecting the traffic, the traffic may be redirected to another AS.

The second node 112 is configured to, e.g. by means of a sending unit 1101 within the second node 112 configured to send, to the first node 111 configured to operate in the communications system 100, the first message. The second node 112 is configured to operate outside of the communications system 100. The first message is configured to indicate: i) the identifier configured to identify the second node 112, ii) the first indication configured to indicate at least one of: i) the one or more target nodes 121 configured to operate outside of the communications system 100 under DoS attack, and ii) the one or more source nodes 122 of the DoS attack, and iii) the second indication configured to indicate the action to be taken in the communications system 100 to mitigate the DoS attack.

In some embodiments, the action may be configured to be at least one of: redirect traffic, block traffic, tear down connections, send traffic to the analytics engine, apply edge computing logic, and apply the authentication service.

In some embodiments, the first indication may be configured to comprise at least one of: the one or more PPFDs, and the one or more application identifiers.

In some embodiments, the first indication may be configured to comprise the respective IP address for each of the one or more source nodes 122.

In some embodiments, the first indication may be configured to lack the respective IP address for each of the one or more source nodes 122.

In some embodiments, one of the following may apply. In some embodiments, the communications system 100 may be configured to be a 5G network, and: the first node 111 may be configured to be the NEF and the second node 112 may be configured to be the AF. In some embodiments, the communications system 100 may be configured to be a 4, network, and: the first node 111 may be configured to be the SCEF, the second node 112 may be configured to be the AS, or the SCS.

In some embodiments, at least one of the following may apply. In some embodiments, the first message may be configured to be the Nnef_Security Request message.

The embodiments herein may be implemented through one or more processors, such as a processor 1102 in the second node 112 depicted in FIG. 11, together with computer program code for performing the functions and actions of the embodiments herein. The program code mentioned above may also be provided as a computer program product, for instance in the form of a data carrier carrying computer program code for performing the embodiments herein when being loaded into the in the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 1103 comprising one or more memory units. The memory 1103 is arranged to be used to store obtained information, store data, configurations, schedulings, and applications etc. to perform the methods herein when being executed in the second node 112.

In some embodiments, the second node 112 may receive information from, e.g., the first node 111, the third node 113, 114, 115, 116, 117, the one or more source nodes 122, the device 130, the one or more target nodes 122 and/or another structure in the communications system 100, through a receiving port 1104. In some examples, the receiving port 1104 may be, for example, connected to one or more antennas in the second node 112. In other embodiments, the second node 112 may receive information from another structure in the communications system 100 through the receiving port 1104. Since the receiving port 1104 may be in communication with the processor 1102, the receiving port 1104 may then send the received information to the processor 1102. The receiving port 1104 may also be configured to receive other information.

The processor 1102 in the second node 112 may be further configured to transmit or send information to e.g., the first node 111, the third node 113, 114, 115, 116, 117, the one or more source nodes 122, the device 130, the one or more target nodes 122 and/or another structure in the communications system 100, through a sending port 1105, which may be in communication with the processor 1102, and the memory 1103.

Those skilled in the art will also appreciate that the units 1101 described above may refer to a combination of analog and digital circuits, and/or one or more processors configured with software and/or firmware, e.g., stored in memory, that, when executed by the one or more processors such as the processor 1102, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

The units 1101 described above may be the processor 1102 of the second node 112, or an application running on such processor.

Thus, the methods according to the embodiments described herein for the second node 112 may be respectively implemented by means of a computer program 1106 product, comprising instructions, i.e., software code portions, which, when executed on at least one processor 1102, cause the at least one processor 1102 to carry out the actions described herein, as performed by the second node 112. The computer program 1106 product may be stored on a computer-readable storage medium 1107. The computer-readable storage medium 1107, having stored thereon the computer program 1106, may comprise instructions which, when executed on at least one processor 1102, cause the at least one processor 1102 to carry out the actions described herein, as performed by the second node 112. In some embodiments, the computer-readable storage medium 1107 may be a non-transitory computer-readable storage medium, such as a CD ROM disc, a memory stick, or stored in the cloud space. In other embodiments, the computer program 1106 product may be stored on a carrier containing the computer program, wherein the carrier is one of an electronic signal, optical signal, radio signal, or the computer-readable storage medium 1107, as described above.

The second node 112 may comprise an interface unit to facilitate communications between the second node 112 and other nodes or devices, e.g., the first node 111, the third node 113, 114, 115, 116, 117, the one or more source nodes 122, the device 130, the one or more target nodes 122 and/or another structure in the communications system 100. In some particular examples, the interface may, for example, include a transceiver configured to transmit and receive radio signals over an air interface in accordance with a suitable standard.

In other embodiments, the second node 112 may comprise the following arrangement depicted in FIG. 11b. The second node 112 may comprise a processing circuitry 1102, e.g., one or more processors such as the processor 1102, in the second node 112 and the memory 1103. The second node 112 may also comprise a radio circuitry 1108, which may comprise e.g., the receiving port 1104 and the sending port 1105. The processing circuitry 1102 may be configured to, or operable to, perform the method actions according to FIG. 6, FIG. 7, and/or FIGS. 8-9, in a similar manner as that described in relation to FIG. 11a. The radio circuitry 1108 may be configured to set up and maintain at least a wireless connection with the first node 111, the third node 113, 114, 115, 116, 117, the one or more source nodes 122, the device 130, the one or more target nodes 122 and/or another structure in the communications system 100.

Hence, embodiments herein also relate to the second node 112 operative to handle the DoS attack. The second node 112 may comprise the processing circuitry 1102 and the memory 1103, said memory 1103 containing instructions executable by said processing circuitry 1102, whereby the second node 112 is further operative to perform the actions described herein in relation to the second node 112, e.g., in FIG. 6, FIG. 7, and/or FIGS. 8-9.

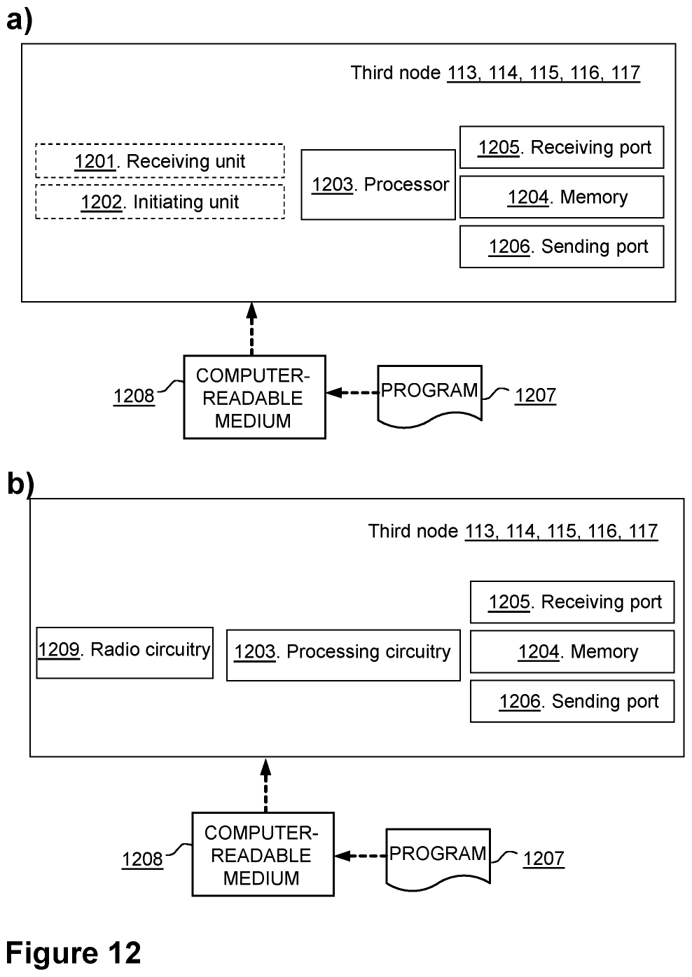

FIG. 12 depicts two different examples in panels a) and b), respectively, of the arrangement that the third node 113, 114, 115, 116, 117 may comprise to perform the method actions described above in relation to FIG. 4, FIG. 7, and/or FIGS. 8-9. In some embodiments, the third node 113, 114, 115, 116, 117 may comprise the following arrangement depicted in FIG. 12a. The third node 113, 114, 115, 116, 117 may be understood to be for handling the DoS attack. The third node 113, 114, 115, 116, 117 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 12, optional boxes are indicated by dashed lines. The detailed description of some of the following corresponds to the same references provided above, in relation to the actions described for the third node 113, 114, 115, 116, 117 and will thus not be repeated here. For example, for embodiments wherein the action may be redirecting the traffic, the traffic may be redirected to another AS.

The third node 113, 114, 115, 116, 117 is configured to, e.g. by means of a receiving unit 1201 within the third node 113, 114, 115, 116, 117 configured to, receive, directly or indirectly, from the first node 111 configured to operate in the communications system 100, the second message. The second message is configured to indicate: ii) the first indication configured to indicate at least one of: i) the one or more target nodes 121 configured to operate outside of the communications system 100 under DoS attack, and ii) the one or more source nodes 122 of the DoS attack, and iii) the second indication configured to indicate the action to be taken in the communications system 100 to mitigate the DoS attack.

The third node 113, 114, 115, 116, 117 is further configured to, e.g. by means of an initiating unit 1202 within the third node 113, 114, 115, 116, 117 configured to, initiate the application of the indicated action in the communications system 100.

In some embodiments the second message may be further configured to indicate an identifier identifying a second node 112 operating outside of the communications system 100.

In some embodiments the second message may be configured to indicate at least one of: a) the identifier, the first indication and the second indication, and b) the first indication and the second indication.

In some embodiments, the action may be configured to be at least one of: redirect traffic, block traffic, tear down connections, send traffic to the analytics engine, apply edge computing logic, and apply the authentication service.

In some embodiments, the first indication may be configured to comprise at least one of: the one or more PPFDs, and the one or more application identifiers.

In some embodiments, the first indication may be configured to comprise the respective IP address for each of the one or more source nodes 122.

In some embodiments, the first indication may be configured to lack the respective IP address for each of the one or more source nodes 122.

In some embodiments, one of the following may apply. In some embodiments, the communications system 100 may be configured to be a 5G network, and: the third node 113, 114, 115, 116, 117 may be configured to be the NEF, the second node 112 may be configured to be the AF, and the one or more third nodes 113, 114, 115, 116, 117 may be configured to comprise one of: the PCF, the UDR, the UPF, the SMF, and the node having the capability to perform machine-learning. In some embodiments, the communications system 100 may be configured to be a 4, network, and: the third node 113, 114, 115, 116, 117 may be configured to be the SCEF, the second node 112 may be configured to be the AS, or the SCS, and the one or more third nodes 113, 114, 115, 116, 117 may be configured to comprise one of: the PCRF, the SPR, the PGW-U, the TDF-U, the PGW-C or the TDF-C, and the node having the capability to perform machine-learning.

In some embodiments, at least one of the following may apply. In some embodiments, the third node 113 may be configured to be one of the PCF or the PCRF, and the initiating of the application of the indicated action may be configured to comprise triggering the rule indicating the action. In some embodiments, the third node 114 may be configured to be one of the UDR or the SPR, and the initiating of the application of the indicated action may be configured to comprise storing information indicated in the first message. In some embodiments, the third node 116 may be configured to be one of the UPF or the PGW-U or the TDF-U, and the initiating of the application of the indicated action may be configured to comprise detecting traffic matching the second indication, and applying the action. In some embodiments, the third node 115 may be configured to be one of the SMF or the PGW-C or the TDF-C, and the initiating of the application of the indicated action may be configured to comprise triggering the rule indicating the action. In some embodiments, the third node 117 may be configured to have the capability to perform machine-learning, and the initiating of the application of the indicated action may be configured to comprise determining the model to predict or identify other DoS attacks. In some embodiments, at least one of the one or more source nodes 122 of the DoS attack may be configured to be the UE.

In some embodiments, at least one of the following may apply. In some embodiments, the second message may be configured to be the Npcf_Policy Request message. In some embodiments, the initiating of the application of the action configured to be indicated may be configured to comprise sending the third message to another third node 115, 116. The third message may be configured to be one of: i) the Npcf_SMPolicyControl_Update Request message to the SMF, wherein the third node 113 may be configured to be the PCF, ii) the PFCP Node Security Request message to the UPF, wherein the third node 115 may be configured to be the SMF, and iii) the PFCP Session Modification Request message to the UPF, wherein the third node 115 may be configured to be the SMF.

The third node 113, 114, 115, 116, 117 may be configured to, e.g. by means of the receiving unit 1201 within the third node 113, 114, 115, 116, 117 configured to, receive, the fourth message from one of the one or more source nodes 122 of the DoS attack. In such embodiments, initiating the application of the action may be further configured to comprise applying the action based on the fourth message configured to be received.

In some embodiments, at least one of the following may apply. In some embodiments, the fourth message may be configured to comprise the respective internet protocol address of the one or more source nodes 122. In some embodiments, the fourth message may lack the respective internet protocol address for each of the one or more source nodes 122.

The embodiments herein may be implemented through one or more processors, such as a processor 1203 in the third node 113, 114, 115, 116, 117 depicted in FIG. 12, together with computer program code for performing the functions and actions of the embodiments herein. The program code mentioned above may also be provided as a computer program product, for instance in the form of a data carrier carrying computer program code for performing the embodiments herein when being loaded into the third node 113, 114, 115, 116, 117. One such carrier may be in the form of a CD ROM disc. It is however feasible with other data carriers such as a memory stick. The computer program code may furthermore be provided as pure program code on a server and downloaded to the third node 113, 114, 115, 116, 117.

The third node 113, 114, 115, 116, 117 may further comprise a memory 1204 comprising one or more memory units. The memory 1204 is arranged to be used to store obtained information, store data, configurations, schedulings, and applications etc. to perform the methods herein when being executed in the third node 113, 114, 115, 116, 117.

In some embodiments, the third node 113, 114, 115, 116, 117 may receive information from, e.g., the first node 111, the second node 112, another the third node 113, 114, 115, 116, 117, the one or more source nodes 122, the one or more target nodes 122 and/or another structure in the communications system 100 through a receiving port 1205. In some examples, the receiving port 1205 may be, for example, connected to one or more antennas in the third node 113, 114, 115, 116, 117. In other embodiments, the third node 113, 114, 115, 116, 117 may receive information from another structure in the communications system 100 through the receiving port 1205. Since the receiving port 1205 may be in communication with the processor 1203, the receiving port 1205 may then send the received information to the processor 1203. The receiving port 1205 may also be configured to receive other information.

The processor 1203 in the third node 113, 114, 115, 116, 117 may be further configured to transmit or send information to e.g., the first node 111, the second node 112, another the third node 113, 114, 115, 116, 117, the one or more source nodes 122, the one or more target nodes 122 and/or another structure in the communications system 100, through a sending port 1206, which may be in communication with the processor 1203, and the memory 1204.

Those skilled in the art will also appreciate that any of the units 1201-1202 described above may refer to a combination of analog and digital circuits, and/or one or more processors configured with software and/or firmware, e.g., stored in memory, that, when executed by the one or more processors such as the processor 1203, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1201-1203 described above may be the processor 1203 of the third node 113, 114, 115, 116, 117, or an application running on such processor.

Thus, the methods according to the embodiments described herein for the third node 113, 114, 115, 116, 117 may be respectively implemented by means of a computer program 1207 product, comprising instructions, i.e., software code portions, which, when executed on at least one processor 1203, cause the at least one processor 1203 to carry out the actions described herein, as performed by the third node 113, 114, 115, 116, 117. The computer program 1207 product may be stored on a computer-readable storage medium 1208. The computer-readable storage medium 1208, having stored thereon the computer program 1207, may comprise instructions which, when executed on at least one processor 1203, cause the at least one processor 1203 to carry out the actions described herein, as performed by the third node 113, 114, 115, 116, 117. In some embodiments, the computer-readable storage medium 1208 may be a non-transitory computer-readable storage medium, such as a CD ROM disc, a memory stick, or stored in the cloud space. In other embodiments, the computer program 1207 product may be stored on a carrier containing the computer program, wherein the carrier is one of an electronic signal, optical signal, radio signal, or the computer-readable storage medium 1208, as described above.

The third node 113, 114, 115, 116, 117 may comprise an interface unit to facilitate communications between the third node 113, 114, 115, 116, 117 and other nodes or devices, e.g., the first node 111, the second node 112, another the third node 113, 114, 115, 116, 117, the one or more source nodes 122, the one or more target nodes 122 and/or another structure in the communications system 100. In some particular examples, the interface may, for example, include a transceiver configured to transmit and receive radio signals over an air interface in accordance with a suitable standard.

In other embodiments, the third node 113, 114, 115, 116, 117 may comprise the following arrangement depicted in FIG. 12b. The third node 113, 114, 115, 116, 117 may comprise a processing circuitry 1203, e.g., one or more processors such as the processor 1203, in the third node 113, 114, 115, 116, 117 and the memory 1204. The third node 113, 114, 115, 116, 117 may also comprise a radio circuitry 1209, which may comprise e.g., the receiving port 1205 and the sending port 1206. The processing circuitry 1203 may be configured to, or operable to, perform the method actions according to FIG. 5, FIG. 7, and/or FIGS. 8-9, in a similar manner as that described in relation to FIG. 12a. The radio circuitry 1209 may be configured to set up and maintain at least a wireless connection with the first node 111, the second node 112, another the third node 113, 114, 115, 116, 117, the one or more source nodes 122, the one or more target nodes 122 and/or another structure in the communications system 100.

Hence, embodiments herein also relate to the third node 113, 114, 115, 116, 117 operative to handle the DoS attack, the third node 113, 114, 115, 116, 117 being operative to operate in the communications system 100. The third node 113, 114, 115, 116, 117 may comprise the processing circuitry 1203 and the memory 1204, said memory 1204 containing instructions executable by said processing circuitry 1203, whereby the third node 113, 114, 115, 116, 117 is further operative to perform the actions described herein in relation to the third node 113, 114, 115, 116, 117, e.g., in FIG. 5, FIG. 7, and/or FIGS. 8-9.

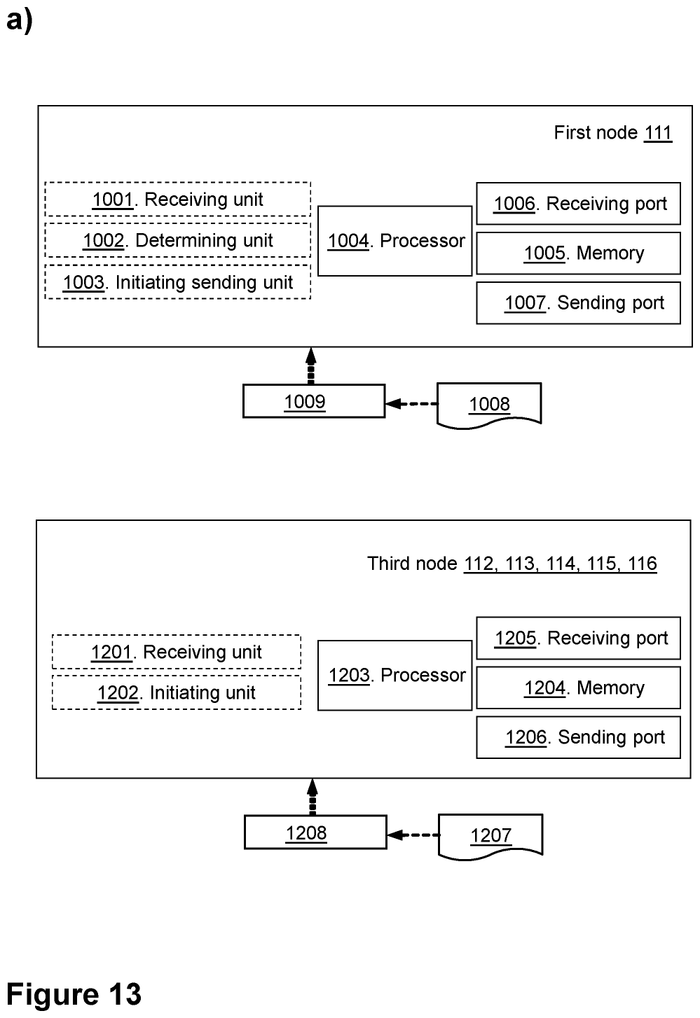

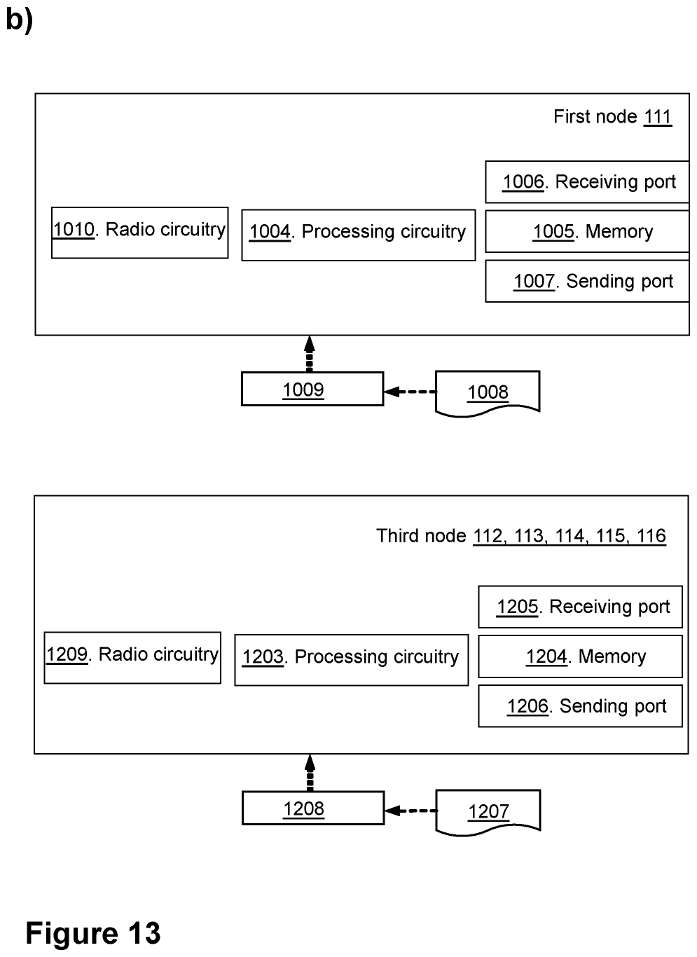

FIG. 13 depicts two different examples in panels a) and b), respectively, of the arrangement that the communications system 100 may comprise to perform the method actions described above in relation to FIG. 7. The arrangement depicted in panel a) corresponds to that described in relation to panel a) in FIG. 10 and FIG. 12 for each of the first node 111 and the third node 113, 114, 115, 116, 117, respectively. The arrangement depicted in panel b) corresponds to that described in relation to panel b) in FIG. 10 and FIG. 12 for each of the first node 111 and the third node 113, 114, 115, 116, 117, respectively. The communications system 100 may be for handling the DoS attack. The communications system 100 is configured to comprise the first node 111 and the one or more third nodes 113, 114, 115, 116, 117.

Several embodiments are comprised herein. Components from one embodiment may be tacitly assumed to be present in another embodiment and it will be obvious to a person skilled in the art how those components may be used in the other exemplary embodiments. In FIG. 13, optional boxes are indicated by dashed lines. The detailed description of some of the following corresponds to the same references provided above, in relation to the actions described for the first node 111 and will thus not be repeated here. For example, for embodiments wherein the action may be redirecting the traffic, the traffic may be redirected to another AS.

The communications system 100 is configured to, e.g. by means of the receiving unit 1001 within the first node 111 configured to, receive, by the first node 111, from the second node 112 configured to operate outside of the communications system 100, the first message configured to indicate: i) the identifier configured to identify the second node 112, ii) the first indication configured to indicate at least one of: i) the one or more target nodes 121 configured to operate outside of the communications system 100, under DoS attack, and ii) the one or more source nodes 122 of the DoS attack, and iii) the second indication configured to indicate the action to be taken in the communications system 100 to mitigate the DoS attack.

The communications system 100 is further configured to, e.g. by means of the initiating sending unit 1002 within the first node 111 configured to, initiate sending, directly or indirectly, by the first node 111, the second message to the one of one or more third nodes 113, 114, 115, 116, 117 configured to operate in the communications system 100. The second message is configured to be based on the first message configured to be received. The second message is configured to initiate the application of the action configured to be indicated in the communications system 100.

The communications system 100 is configured to, e.g. by means of the receiving unit 1201 within the third node 113, 114, 115, 116, 117 configured to, receive, directly or indirectly, by the one of one or more third nodes 113, 114, 115, 116, 117, from the first node 111, the second message.

The communications system 100 is further configured to, e.g. by means of the initiating unit 1202 within the third node 113, 114, 115, 116, 117 configured to, initiate, by the one of one or more third nodes 113, 114, 115, 116, 117, the application of the action configured to be indicated in the communications system 100.

In some embodiments the second message may be configured to indicate at least one of: a) the identifier, the first indication and the second indication, and b) the first indication and the second indication.

In some embodiments, the action may be configured to be at least one of: redirect traffic, block traffic, tear down connections, send traffic to the analytics engine, apply edge computing logic, and apply an authentication service.

In some embodiments, the first indication may be configured to comprise at least one of: the one or more PPFDs, and the one or more application identifiers.

In some embodiments, the first indication may be configured to comprise the respective IP address for each of the one or more source nodes 122.

In some embodiments, the first indication may be configured to lack the respective IP address for each of the one or more source nodes 122.

The communications system 100 may also be configured to, e.g. by means of a determining unit 1003 within the first node 111 configured to, determine, by the first node 111, whether or not the second node 112 may be authorized to request the action to be taken. In such embodiments, the second message may be configured to be sent with the proviso the second node 112 is authorized.

In some embodiments, one of the following may apply. In some embodiments, the communications system 100 may be configured to be a 5G network, and: the first node 111 may be configured to be the NEF, the second node 112 may be configured to be the AF, and the one or more third nodes 113, 114, 115, 116, 117 may be configured to comprise one of: the PCF, the UDR, the UPF, the SMF, and the node having the capability to perform machine-learning. In some embodiments, the communications system 100 may be configured to be a 4, network, and: the first node 111 may be configured to be the SCEF, the second node 112 may be configured to be the AS, or the SCS, and the one or more third nodes 113, 114, 115, 116, 117 may be configured to comprise one of: the PCRF, the SPR, the PGW-U, the TDF-U, the PGW-C or the TDF-C, and the node having the capability to perform machine-learning.

In some embodiments, at least one of the following may apply. In some embodiments, the third node 113 may be configured to be one of the PCF or the PCRF, and the initiating of the application of the indicated action may be configured to comprise triggering the rule indicating the action. In some embodiments, the third node 114 may be configured to be one of the UDR or the SPR, and the initiating of the application of the indicated action may be configured to comprise storing information indicated in the first message. In some embodiments, the third node 116 may be configured to be one of the UPF or the PGW-U or the TDF-U, and the initiating of the application of the indicated action may be configured to comprise detecting traffic matching the second indication, and applying the action. In some embodiments, the third node 115 may be configured to be one of the SMF or the PGW-C or the TDF-C, and the initiating of the application of the indicated action may be configured to comprise triggering the rule indicating the action. In some embodiments, the third node 117 may be configured to have the capability to perform machine-learning, and the initiating of the application of the indicated action may be configured to comprise determining the model to predict or identify other DoS attacks. In some embodiments, at least one of the one or more source nodes 122 of the DoS attack may be configured to be the UE.

In some embodiments, at least one of the following may apply. In some embodiments, the second message may be configured to be the Npcf_Policy Request message. In some embodiments, the initiating of the application of the action configured to be indicated may be configured to comprise sending the third message to another third node 115, 116. The third message may be configured to be one of: i) the Npcf_SMPolicyControl_Update Request message to the SMF, wherein the third node 113 may be configured to be the PCF, ii) the PFCP Node Security Request message to the UPF, wherein the third node 115 may be configured to be the SMF, and iii) the PFCP Session Modification Request message to the UPF, wherein the third node 115 may be configured to be the SMF.

The communications system 100 may be configured to, e.g. by means of the receiving unit 1201 within the third node 113, 114, 115, 116, 117 configured to, receive, by the one of one or more third nodes 116, the fourth message from one of the one or more source nodes 122 of the DoS attack. In such embodiments, initiating the application of the action may be further configured to comprise applying the action based on the fourth message configured to be received.

In some embodiments, at least one of the following may apply. In some embodiments, the fourth message may be configured to comprise the respective internet protocol address of the one or more source nodes 122. In some embodiments, the fourth message may lack the respective internet protocol address for each of the one or more source nodes 122.

In some embodiments, at least one of the following may apply. In some embodiments, the first message may be configured to be the Nnef_Security Request message, and the second message may be configured to be at least one of: the Npcf_Policy Request message, the Npcf_PolicyAuthorization Request message, and the Nudr_Store Request message.

The remaining hardware components and the remaining configurations described for the first node 111 and the third node 113, 114, 115, 116, 117, in relation to FIG. 13, may be understood to correspond to those described in FIG. 10, and FIG. 12, respectively, and to be performed, e.g., by means of the corresponding units and arrangements described in FIG. 10 and FIG. 12, which will not be repeated here. It may be understood that the communications system 100 may be in communication/connected to, the second node 112 described in relation to FIG. 11.

When using the word “comprise” or “comprising”, it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of: ” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of: ” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

1-80. (canceled)

81. A method performed by a first node, for handling a Denial of Service (DoS) attack, the first node operating in a communications system, and the method comprising:
receiving, from a second node operating outside of the communications system, a first message indicating: an identifier identifying the second node; a first indication indicating at least one of one or more target nodes operating outside of the communications system, under DoS attack, or one or more source nodes of the DoS attack; and a second indication indicating an action to be taken in the communications system to mitigate the DoS attack; and
initiating sending, directly or indirectly, a second message to one of one or more third nodes operating in the communications system, the second message being based on the received first message, and the second message initiating an application of the indicated action in the communications system.

82. The method according to claim 81, wherein the second message indicates at least one of:
the identifier, the first indication and the second indication, and
the first indication and the second indication.

83. The method according to claim 81, wherein the action is at least one of:
redirect traffic;
block traffic;
tear down connections;
send traffic to an analytics engine,
apply edge computing logic; and
apply an authentication service.

84. The method according to claim 81, wherein the first indication comprises at least one of: one or more Packet Flow Descriptions (PFDs), or one or more application identifiers.

85. The method according to claim 81, wherein the first indication comprises a respective internet protocol address for each of the one or more source nodes.

86. The method according to claim 81, wherein the first indication lacks a respective internet protocol address for each of the one or more source nodes.

87. The method according to claim 81, the method further comprising:
determining whether or not the second node is authorized to request the action to be taken, and wherein the second message is sent with the proviso the second node is authorized.

88. The method according to claim 81, wherein:
the communications system is a Fifth Generation (5G) network, the first node is a Network Exposure Function (NEF), the second node is an Application Function (AF), and the one or more third nodes comprise one of: a Policy Control Function (PCF), an Unified Data Repository (UDR), a User Plane Function (UPF), a Session Management Function (SMF), and a node configured to perform machine-learning; or
the communications system is a Fourth Generation (4G) network, the first node is a Service Capability Exposure Function (SCEF), the second node is an Application Server (AS) or a Service Capability Server (SCS), and the one or more third nodes comprise one of: a Policy Control Rules Function (PCRF), a Subscriber Profile Repository (SPR), a Packet Data Network Gateway User plane function (PGW-U), a Traffic Detection Function User Plane function (TDF-U), a Packet Data Network Gateway Control plane function (PGW-C), a Traffic Detection Function Control Plane function (TDF-C), or a node configured to perform machine-learning.

89. The method according to claim 88, wherein at least one of:
the third node is one of a PCF or a PCRF, and the initiating of the application of the indicated action comprises triggering a rule indicating the action;
the third node is one of a UDR or an SPR, and the initiating of the application of the indicated action comprises storing information indicated in the first message;
the third node is one of a UPF or an PGW-U or an TDF-U, and the initiating of the application of the indicated action comprises detecting traffic matching the second indication, and applying the action;
the third node is one of a SMF or an PGW-C or an TDF-C, and the initiating of the application of the indicated action comprises triggering a rule indicating the action;
the third node has a capability to perform machine-learning, and the initiating of the application of the indicated action comprises determining a model to predict or identify other DoS attacks; or
at least one of the one or more source nodes of the DoS attack is a User Equipment (UE).

90. The method according to claim 81, wherein at least one of:
the first message is a Nnef_Security Request message, or the second message is at least one of a Npcf_Policy Request message, a Npcf_Policy Authorization Request message, or a Nudr_Store Request message.

91. A first node configured for operation in a communications system, and wherein the first node is further configured for handling Denial of Service (DoS) attacks and comprises:
interface circuitry configured to receive a first message from a second node that is outside of the communications system, the first message comprising: an identifier of the second node; a first indication that indicates one or more target nodes outside of the communications system under a DoS attack or one or more source nodes of the DoS attack; and a second indication that indicates an action to be taken in the communications system to mitigate the DoS attack; and
processing circuitry operatively associated with the interface circuitry and configured to initiate application of the action in the communications system by sending, directly or indirectly, a second message to a third node in the communications system.

92. A method for handling a Denial of Service (DoS) attack, the method performed by a node operating in a communications system and comprising:
receiving a message directly or indirectly from another node operating in the communications system, the message containing a first indication and a second indication and wherein the first indication indicates at least one of one or more target nodes outside of the communications system under DoS attack or one or more source nodes of the DoS attack, and the second indication indicates an action to be taken in the communications system to mitigate the DoS attack; and
initiating an application of the indicated action in the communications system.

93. The method according to claim 92, wherein the message further indicates an identifier identifying a further node originating a request for mitigation of the DoS attack, the further node operating outside of the communications system.

94. The method according to claim 93, wherein:
the communications system is a Fifth Generation (5G) network, and the other node is a Network Exposure Function (NEF), the further node is an Application Function (AF), and the node comprises one of a Policy Control Function (PCF), a Unified Data Repository (UDR), a User Plane Function (UPF), a Session Management Function (SMF), or a node configured to perform machine-learning; or
the communications system is a Fourth Generation (4G) network, and the other node is a Service Capability Exposure Function (SCEF), the further node is an Application Server (AS) or a Service Capability Server (SCS), and the node comprises one of a Policy Control Rules Function (PCRF), a Subscriber Profile Repository (SPR), a Packet Data Network Gateway User plane function (PGW-U), a Traffic Detection Function User Plane function (TDF-U), a Packet Data Network Gateway Control plane function (PGW-C), or a Traffic Detection Function Control Plane function (TDF-C), or a node configured to perform machine-learning.

95. The method according to claim 94, wherein:
the node is a PCF or a PCRF, and initiating application of the action comprises triggering a rule indicating the action;
the third node is a UDR or a SPR, and initiating of application of the action comprises storing information indicated in the message;
the third node is a UPF or a PGW-U or a TDF-U, and initiating application of the action comprises detecting traffic subject to the action and applying the action to the detected traffic;
the third node is a SMF or a PGW-C or a TDF-C, and initiating application of the action comprises triggering a rule indicating the action; or
the third node is a machine-learning node, and initiating application of the action comprises determining a model to predict or identify other DoS attacks.

96. The method according to claim 92, wherein the first indication indicates that at least one of the one or more source nodes of the DoS attack is a User Equipment (UE).

97. The method according to claim 92, wherein the action is at least one of:
redirect traffic,
block traffic,
tear down connections,
send traffic to an analytics engine,
apply edge computing logic, and
apply an authentication service.

98. A method for handling a Denial of Service (DoS) attack, the method performed by a node operating outside a communications system and comprising:
sending a message to a first node operating in the communications system, the message indicating: an identifier identifying the node; a first indication indicating at least one of one or more target nodes operating outside of the communications system and under DoS attack, or one or more source nodes of the DoS attack; and a second indication indicating an action to be taken in the communications system to mitigate the DoS attack.

99. The method according to claim 98, wherein the communications system is a Fifth Generation (5G) network and sending the message comprises sending the message to a Network Exposure Function (NEF) as the first node, or the communications system is a Fourth Generation (4G) network, and sending the message comprises sending the message to a Service Capability Exposure Function (SCEF) as the first node.

100. The method according to claim 98, wherein the first indication included in the message indicates that one or more User Equipments (UEs) are source nodes of the DoS attack.
